(19) United States
(12) Patent Application Publication
(10) Pub. No.: US 2024/0405900 A1
(43) Pub. Date: Dec. 5, 2024

(54) WAYPOINTS FOR LAST KNOWN NETWORK CONNECTIVITY

(71) Applicant: Apple Inc., Cupertino, CA (US)

(72) Inventors: Jared K. McGann, San Jose, CA (US); Stephen P. Jackson, San Francisco, CA (US); Adam M. Driscoll, Atherton, CA (US); Alexandru Popovici, Santa Clara, CA (US); Nicholas D. Felton, Sunnyvale, CA (US); Todd R. Grooms, Nashville, TN (US)

(73) Assignee: Apple Inc., Cupertino, CA (US)

(21) Appl. No.: 18/733,658

(22) Filed: Jun. 4, 2024

Related U.S. Application Data
(60) Provisional application No. 63/506,362, filed on Jun. 5, 2023.

(51) Int. Cl. H04B 17/318; H04W 4/02

(52) U.S. Cl. CPC H04B 17/318; H04W 4/02

(57) ABSTRACT

Waypoints can be automatically created by monitoring network wireless signal strength to help a user of a mobile device in a non-urban location to find a previous location with known network connectivity and make emergency calls. In some embodiments, a backtrack route is displayed on the mobile device to the closest previous location with network connectivity. In some embodiments, for privacy considerations, access to waypoint information stored in a secured storage/database is restricted based on the determination of location state, and backtrack routes are displayed in stages.

### CROSS-REFERENCES TO RELATED APPLICATIONS

This application is a non-provisional of and claims the benefit and priority under 35 U.S.C. 119 (e) of U.S. Provisional Application No. 63/506,362, titled “WAYPOINTS FOR LAST KNOWN NETWORK CONNECTIVITY,” filed on Jun. 5, 2023, which is incorporated herein by reference in its entirety for all purposes.

### BACKGROUND

When in remote areas (e.g., while hiking), cell coverage may be lost. If an emergency occurs, a person may not be able to make an emergency call, e.g., to 911. It is desirable to provide information to the user about the closest location to make such an emergency call.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method performed by one or more processors of a first mobile device. The method also includes monitoring a strength of a network wireless signal. The method also includes storing a first previous location of the first mobile device at a first previous time when the strength of the network wireless signal was above a threshold. The method also includes receiving a request to provide information about previous network connectivity of the first mobile device. The method also includes responsive to the request, retrieving the first previous location. The method also includes providing the first previous location to a user of the first mobile device. Other embodiments of this aspect include corresponding computer systems, apparatus, and computer programs recorded on one or more computer storage devices, each configured to perform the actions of the methods.

Another general aspect includes a method performed by one or more processors of a first mobile device. The method also includes receiving a target altitude. The method also includes monitoring a current altitude of the first mobile device. The method also includes providing a first notification when the current altitude matches the target altitude. The method also includes disabling notifications after the first notification. The method also includes continuing to monitor the current altitude of the first mobile device. The method also includes enabling notifications when the current altitude differs from the target altitude by more than a threshold amount.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 is a block diagram of a network operating environment for electronic devices, according to an embodiment.

FIG. 2 is a block diagram for location services, according to an embodiment.

FIG. 3A-3B depict user interfaces for location services, in accordance with an embodiment.

FIG. 4 is a flow chart illustrating a location services approach, according to an embodiment.

FIG. 5 is a diagram illustrating waypoints for the last known network connectivity and backtracking, according to some embodiments.

FIG. 6 shows a diagram for providing location information about when a network signal was last available, according to some embodiments.

FIG. 7 is a flowchart illustrating a method for providing location information about when a network signal was last available, according to some embodiments.

FIG. 8 is a flowchart illustrating a method for providing location information with privacy safeguards, according to some embodiments.

FIGS. 9A-9Q illustrates exemplary user interfaces for transitioning among different views of indications of locations, in accordance with some embodiments.

FIG. 10 is a flow diagram illustrating methods of transitioning among different views of indications of locations, in accordance with some embodiments.

FIG. 11 illustrates a vertical geofence at a target altitude (elevation) and alerts when the target altitude is reached, according to some embodiments.

FIG. 12 illustrates the vertical geofence notifications when a user travels above and below a target altitude, according to some embodiments

FIG. 13 illustrates a mechanism to prevent unwanted notifications, according to some embodiments.

FIG. 14 illustrates a mechanism to prevent unwanted notifications using a vertical geofence signal, according to some embodiments

FIG. 15 shows the operation of a framework to track altitude and provide notifications, according to some embodiments.

FIG. 16 is a flowchart illustrating a method of triggering an alert at a target altitude, according to some embodiments.

FIG. 17 is a block diagram of an example device, which may be a mobile device, according to some embodiments.

### Terms

A waypoint is an intermediate point or place on a route or on a path the user traveled that may be defined by a set of coordinates (e.g., latitude and longitude, a GPS point, etc.) to identify the point in physical space. A navigation application may use the coordinates of the waypoint position to track and display distance and bearing information of the waypoint position as compared to a current position of the electronic device.

Bearing information provides a compass direction from an electronic device position to a waypoint position. In some embodiments, the bearing information is the horizontal angle between the waypoint position and a direction of travel of the electronic device, or the horizontal angle between the electronic device determined position and magnetic north or true north, depending on the implementation. By way of example, if the user is holding the electronic device to point and travel with the electronic device in the direction of due north and the waypoint position is directly behind where the electronic device is pointed, then the bearing would be south. Relative bearing refers to the angle between the electronic device direction of travel and the location of waypoint position.

In some embodiments, device context is a set of conditions that when met determine which location type (e.g., urban, or back country) a mobile device is in. As examples, the location type can be determined using motion classification (e.g., driving, walking, stationary, etc.), wireless signals (e.g., Wi-Fi, cellular, Bluetooth, and the like) and how many, and a map tile category (e.g., whether tile is classified as urban or not). Data may be analyzed to determine if the device context exists to trigger a change in the location type.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive.

Location services may request waypoint information including, but not limited to, positioning information, and bearing information (e.g., GPS data, GPS points, etc.) repeatedly over a period of time to assist with tracking and navigation to the waypoint position. In some embodiments, the electronic device may provide directions to a waypoint position, a trajectory of travel to the waypoint position, and a distance to the waypoint position. For example, the electronic device may repeatedly request positioning information for a current position of the electronic device while the user is in transit in order to continuously calculate the distance relative to the waypoint position. In another example, bearing information may be calculated repeatedly with received positioning information.

In some embodiments, two types of waypoint positions (also referred to as waypoints) may be created: a cellular waypoint for tracking cellular connectivity and an SOS waypoint for tracking SOS connectivity. The waypoint information may include times and/or locations when a mobile device (e.g., a wearable device such as a watch) or a companion device (e.g., a phone or a tablet paired with the device) last had a network signal, e.g., a cellular signal or other wide area network signal. Signal reception can be tracked, e.g., using the same modules for providing signal strength to a display on the mobile device or the companion device. The signal strength can be monitored and saved periodically, potentially only saving the times and/or locations when the signal strength fell below a threshold. The signal strength can be saved as a bit flag indicating that the signal was above or below the threshold or saved a numerical value. A time and a signal strength can be saved in a first table or database. For example, one or more times and/or locations when the mobile device last had a network signal above a threshold can be saved.

In some embodiments, the locations of the mobile device can be saved separately (e.g., in a second table or database) from the time events for network signal strength (e.g., in a first table or database). This location database can be saved in a secure storage that is accessible only by certain system routines, which can provide such information to a user only when certain criteria is met (e.g., location type is one where signal is likely to be lost, such as in a non-urban location state).

The times when the signal strength was last above a threshold can be used to retrieve the corresponding location from the second table that includes time as a field. In some implementations, for privacy, the location at the last available network wireless signal can be provided only when the device is classified to be in a non-urban location state (e.g., a rural state, a backcountry state, etc.). As examples, such a state (also called a location type) can be determined using motion classification (e.g., driving, walking, stationary, etc.), wireless signals (e.g., Wi-Fi, cellular, Bluetooth, and the like) and how many, and a map tile category (e.g., whether tile is classified as urban or not). In some embodiments, access to the location information may be restricted to a specific time that is determined to be still in a non-urban location state instead of all recorded history. In this manner, the information about the locations is only provided when needed, thereby reducing chances such location information could be misused.

The mobile device can retrieve one or more previous locations when the mobile device had an available signal (i.e., a signal was above a threshold). These locations can be displayed as waypoints on a device. Multiple locations can be retrieved, for example, in case it is easier or faster for the user of the mobile device to reach an earlier location with an available signal, as may occur when hiking. The waypoints can be displayed with an icon or text indicating that the waypoint indicated a previous location having an available signal. In some embodiments, for privacy, the waypoints may be displayed in stages if the signal strength of a particular waypoint has changed when the mobile device reaches that particular waypoint.

In some implementations, more than one type of network signal can be monitored. For example, an out of network signal (e.g., for any other carrier than the mobile device uses) can be tracked, as such other networks can still allow for an emergency call to be made. If the in-network waypoint and the out of network waypoint are close together (e.g., within a proximity threshold), then just the in-network waypoint can be displayed.

A display of a waypoint (e.g., the available signal waypoint) can be provided in a compass application or a map application. The previous locations that are saved in the second database can be used to provide a path for the user to backtrack to the last known location with a signal.

In some embodiments, the current altitude of a mobile device may be monitored to trigger an alert (or notification) when the device reaches a target altitude. A programmable threshold amount of altitude may be added around the monitored altitude to reduce unwanted notifications by enabling and disabling notifications at appropriate times.

Embodiments of the present disclosure provide a number of advantages. For example, instead of requiring a user of a mobile device to manually create waypoints while traveling, the automatically generated cellular/SOS waypoints are more accurate since the network wireless signal strength is continuously monitored.

In addition, the network wireless signals can be vital and potentially life-saving when the user of a mobile device is in a non-urban location (or backcountry) state. The automatically generated cellular/SOS waypoints can also avoid distracting the user of the mobile device while hiking in difficult or unfamiliar terrain.

Finally, privacy safeguards for historical information access (e.g., restricted access to location information in a secured storage/database and in time) and backtrack route display (e.g., single waypoint, multiple waypoints, or staged display of waypoints) based on location state address the concern when personal travel routes are automatically tracked.

### I. Network Communications and Determining Location

An electronic device (e.g., a mobile device) may have locally accessible services, such as location services, or externally accessible services (e.g., telephony service, storage service, and device locator service) through a network connection (e.g., internet).

### A. Network Operating Environment

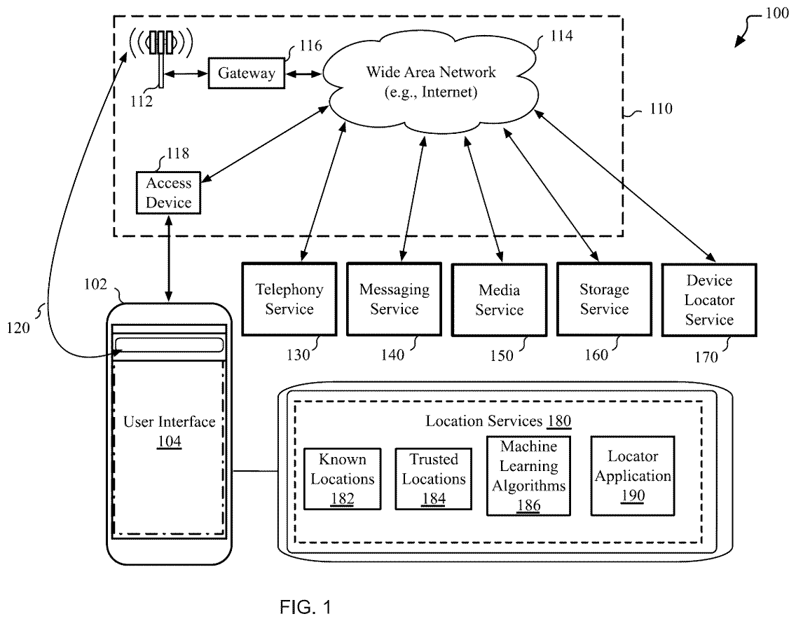

FIG. 1 is a block diagram of a network operating environment 100 for electronic devices, according to an embodiment. The network operating environment 100 includes electronic devices 102, such as a mobile device. Mobile devices can be any electronic device 102 capable of communicating over a wireless network and/or a wireless accessory device. Some examples of mobile devices include, but are not limited to, the following: a smartphone, a tablet computer, a notebook computer, a wearable device (e.g., smartwatch or other wearable computing accessory), a mobile media player, a personal digital assistant, AirPods®, EarPods®, PowerBeats®, AirTag®, locator tags, headphones, head mounted display, health equipment, speakers, and other similar devices. In an embodiment, an accessory device may be paired with electronic device 102. By way of example, accessory devices may be devices such as Apple AirPods®, EarPods®, PowerBeats®, exercise equipment, vehicles, bicycles, scooters, smart televisions, HomePod®, HomePod Mini®, automated assistant devices, home security systems, and/or any other mobile accessory device.

Each of electronic devices 102 optionally can include a user interface, such as user interface 104 of electronic device 102. In other embodiments, an electronic device 102, may not have a user interface. Electronic devices 102 may be a third-party device that utilizes an application programming interface to access device locator services. The third-party device may be provided by a different device manufacturer or be part of a different ecosystem (e.g., operating system) from electronic device 102. Electronic device 102 can communicate over one or more wired and/or wireless networks 110 to perform data communication. For example, a wireless network 112 (e.g., cellular network, Wi-Fi network) can communicate with a wide area network 114, such as the Internet, by use of a gateway 116. Likewise, an access device 118, such as a mobile hotspot wireless access device, can provide communication access to the wide area network 114. The gateway 116 and access device 118 can then communicate with the wide area network 114 over a combination of wired and/or wireless networks.

In some implementations, both voice and data communications can be established over the wireless network 112 and/or the access device 118. For example, electronic device 102 can place and receive phone calls (e.g., using VoIP protocols), send and receive e-mail messages (e.g., using POP3 protocol), and retrieve electronic documents and/or streams, such as web pages, photographs, and videos, over the wireless network 112 (as shown with 120), gateway 116, and wide area network 114 (e.g., using TCP/IP or UDP protocols). In some implementations, electronic device 102 can place and receive phone calls, send, and receive e-mail messages, and retrieve electronic documents over the access device 118 and the wide area network 114. In some implementations, electronic device 102 can be physically connected to the access device 118 using one or more cables, for example, where the access device 118 is a personal computer. In this configuration, electronic device 102 can be referred to as a “tethered” device. In one embodiment, electronic device 102 can communicate with accessory devices via a wireless peer-to-peer connection. The wireless peer-to-peer connection (not shown) can be used to synchronize data between the devices.

Electronic device 102 can communicate with one or more services, such as a telephony service 130, a messaging service 140, a media service 150, a storage service 160, and a device locator service 170 over the one or more wired and/or wireless networks 110. For example, the telephony service 130 can enable telephonic communication between electronic devices or between an electronic device and a wired telephonic device. The telephony service 130 can route voice over IP (VOIP) calls over the wide area network 114 or can access a cellular voice network (e.g., wireless network 112). The messaging service 140 can, for example, provide e-mail and/or other messaging services. The media service 150 can, for example, provide access to media files, such as song files, audio books, movie files, video clips, and other media data. The storage service 160 can provide network storage capabilities to electronic device 102 to store documents and media files. The device locator service 170 can enable a user to locate a lost or misplaced device that was, at least at some point, connected to the one or more wired and/or wireless networks 110. Other services can also be provided, including a software update service to update operating system software or client software on the electronic devices. In one embodiment, the messaging service 140, media service 150, storage service 160, and device locator service 170 can each be associated with a cloud service provider, where the various services are facilitated via a cloud services account associated with the electronic devices 102.

Electronic device 102 may have applications, services, application programming interfaces, and functionality locally accessible on the devices including and/or utilizing location services 180. Electronic devices 102 may offer one or more device locator applications 190 (e.g., a “Find my” application, a “Compass” application, a mapping application, etc.) to utilize device locator services 170 and location services 180 to locate accessory devices, provide a mapping application, and a navigation application. The navigation application (e.g., a “Compass” application) to aid the user in navigating and backtracking to historical positions on their route. The navigation application is an application that shows the cardinal directions used for navigation and geographic orientation using any number of methods including gyroscopes, magnetometers and/or positioning systems (e.g., GPS receivers). The mapping application is an application that uses maps delivered by a geographic information system (GIS). The backtrack route may be the set of historical positions obtained over a window of time that allows the user to retrace their steps.

Locally accessible data may be stored on defined locations, such as known locations 182 and safe, trusted locations 184. Machine learning algorithms 186 may be used to classify locations, infer relationships between a user and locations, provide path reconstruction and/or distance estimates in embodiments. In some embodiments, machine learning algorithms 186 may be used to provide an estimate for a distance with a set of features, including, but not limited to, intermittently received position fixes for a path and a straightness metric for a set of position fixes.

In some instances, machine learning algorithms 186 may be used to identify known locations 182, and/or trusted locations 184. By way of example, cluster data analysis may be used to identify, classify, and provide semantic labels for locations, such as locations frequented by a user. Safe, trusted locations 184 may be designated explicitly or confirmed as such by a user of the electronic device 102 after data analysis. In other instances, the known locations 182 or the trusted locations 184 may be classified offline and provided by device locator service 170 or a third-party (e.g., a database with map information). Although cluster analysis is provided as an example of machine learning algorithms that may be used, those with skill in the art will recognize that other algorithms may be used to identify potential known or trusted locations.

On-device heuristics and/or machine learning models may be used to infer relationships between a user and locations based on analysis of the locally stored data on frequented locations including frequently visited locations by the user, known locations, and/or any other locations. For example, a frequently visited location such as a home, a vehicle, a workplace, any location frequented by a user with electronic device (e.g., accessory devices, and electronic device 102) and/or any other location designated as a trusted location 184 by the user. Known locations 182 may be business locations, public spaces, parks, museums, and/or any other location that may be frequented by a user.

Defined locations may have associated fence information that provides a set of conditions, if detected, allow for designating or classifying an electronic device relative to a region of physical space for at least a portion of the defined location. For example, fence information may provide the conditions for classifying the electronic device as either inside or outside a region of physical space associated with the defined location. In another example, fence information may provide the conditions for classifying the electronic device as transitioning between inside or outside the region of the defined location. Fence information may be a geofence with boundary information for the defined location, such as a point location and the extents of the region from the point location (e.g., a circular region defined with a radius from the point location, a polygon shape with distance measurements from the point location, etc.). Fence information may include a set of sensor measurements received by electronic devices (e.g., fingerprint data including radio frequency (RF) scan data, such as Wi-Fi scan traces, etc.) that are characteristic of a particular region of the defined location. Fence information for the respective defined locations may be stored along with classification type for the location and any semantic label assigned to the location. Boundary information may include a defined set of boundaries or a radius distance around a point location to allow for creation of a fence for the location. In some embodiments, the fence is a virtual perimeter for a real-world geographic area. Global positioning system (GPS) may be used to create a virtual fence around a location and track the physical location of the electronic device 102 within the geofence boundary as well as entry and exit of the bounded area. In some embodiments, there are at least two tiers of fences that may be used to reduce traditional geofence latency. For example, the mode selected based on analysis of user contextual data to determine intent may factor into selection of the granularity of the fence established. In some embodiments, multiple fences may be used to refine positioning information determined by a coarse-grained geofence.

Machine learning algorithms 186 may include on-device heuristics, machine learning algorithms, or a combination thereof to analyze and assign a label describing a user context, such as a location status. The location status may be a label for a user context (e.g., set of conditions, a motion classification) in which specific positioning techniques and resources of the electronic device are used to obtain positioning information. The location status may define a current location state and/or a prediction of a change in location state of a user while traveling with the electronic device. By proactively obtaining positioning information using techniques appropriate for the location status, latency is reduced in provision of the information for device applications without incurring a noticeable decline in performance of the electronic device that may be experienced with constant requests for positioning information. For example, the user context may indicate movement or travel of an electronic device to allow the electronic device to be designated as having a motion classification, such as “in transit,” “settled” in a particular defined location for a time period, or any other defined motion classification. Analysis may be performed using a variety of signals from contextual user data sources available to the electronic device 102, including, but not limited to, the following: sensor data, positioning data, calendar data, transit card usage data, application data, historical data on patterns/routines of travel, wireless connection status with accessory devices and/or services (e.g., Bluetooth connection status), device location history, and/or any other data accessible to the electronic device 102. In an embodiment, the wireless connection status with various devices may indicate that the device is settled or “in transit.” For example, a loss of a connection to an appliance, a security system, a heating/cooling systems, vehicles, other modes of transport, and/or any other devices may indicate that the electronic device is “in transit.”

In some embodiments, an electronic device 102 may be classified with a “settled” semantic label after remaining within the geographic boundaries that define a location (e.g., the trusted location 184) for a defined time period. In an example, received positioning data for the electronic device 102 may indicate the electronic device 102 remained within the boundaries of a fence for a particular location for a duration of time (e.g., 5 minutes). Sensor data, such as accelerometer data, may indicate that the electronic device 102 is at rest to support an inference of being settled. Application data may support the inference that the electronic device 102 is settled, such as the electronic device being located at a calendar appointment location. Application data indicating a type of application in use may also provide an inference of the device being settled, such as using a media application. Historical data for the user on routines or patterns in travel may be used to determine whether the electronic device 102 is settled, such as a bedtime routine at a home or a hotel location.

Electronic device 102 may be classified as having an “in transit” label based on prior detected behavior, patterns, or routines for the user, and analyzed on electronic device 102. For example, the user may have routine of going to work around the same time every day and an “in transit” state may be assigned if the data on the device supports that the pattern is being repeated. A speed at which the electronic device is moving or entering and exiting known geographic areas (e.g., using fences) may allow for the inferring that the electronic device 102 is in transit. If the electronic device 102 is detected as accelerating in known areas of transit (e.g., on roads, highways, train routes, etc.), then the electronic device 102 may be given the motion classification of “in transit.” Similarly, if transit applications/cards are used/in use, then the electronic device 102 may be designated as “in transit”.

Electronic device 102 may be classified as a “threshold distance,” “near an entry,” “near an exit,” “entry” and/or “exit” of a set of locations or a particular location based on crossing fence boundaries for the respective location or set of locations and/or detecting a pattern of sensor values that are characteristic of being in a location, such as Wi-Fi scan results characteristic of being inside a location or transitioning into a location.

### B. Location Services

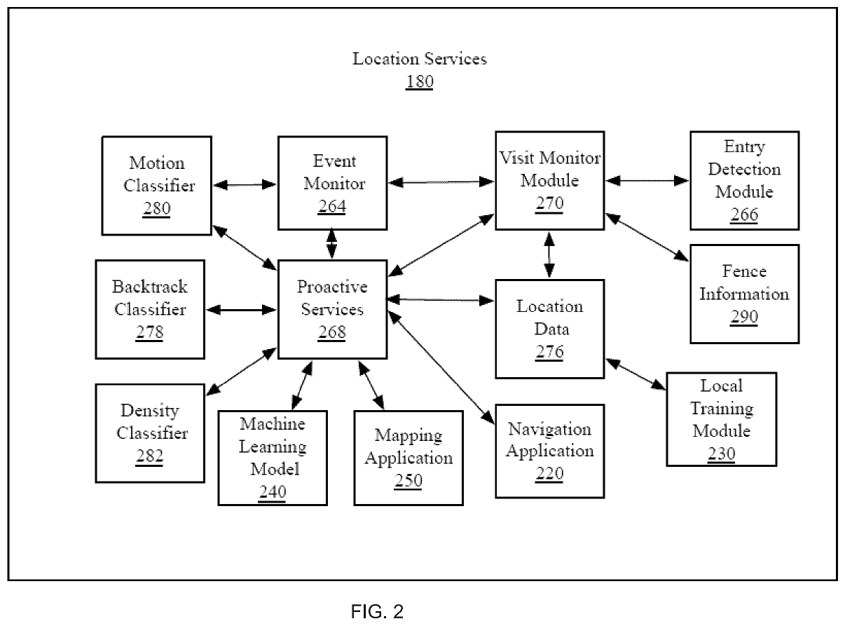

FIG. 2 is a block diagram for location services, according to an embodiment. Location services 180 may include an event monitor module 264 (e.g., a fence event monitor, location status monitor, sensor monitor, etc.) that may aid in determining when power and performance modes should be adjusted for determining positioning and/or bearing information. Event monitor module 264 may rely on data from contextual user data sources to serve as cues for user context and event monitor module 264 may use heuristics and/or machine learning algorithms 186 to determine user contexts that trigger adjustment of modes. In some embodiments, user context and a location state may determine adjustments to power and performance modes executed on the electronic device 102. The location state of the user of is either in a defined location or traveling between locations. By taking into consideration the location state of the user and user context (e.g., information from motion sensors, application data), positioning and/or bearing information may be provided in anticipation of the user needing the information.

In some embodiments, the events monitor module 264 may use data to determine adjustments to modes that may impact power or performance for the operation of the electronic device 102. For example, the user context of the electronic device 102 may include a designation of “in transit” using a motion classifier 280 and wireless connection status data that a Bluetooth connection is lost between the electronic device 102 and an accessory device, such as a vehicle entertainment system. Continuing with the example, the events monitor module 264 may determine from one or more contextual user data sources (e.g., motion classifier, wireless connection status) that there is at least one indication that there will be a change in location status and/or motion classification of the electronic device 102, such as the electronic device 102 may be “in transit to a defined location” because the user is “in transit” and lost the Bluetooth connection to the vehicle entertainment system, so the user may have exited the vehicle and is in transit to a location. Crossing fence boundaries for one or more defined locations may indicate that the user intends to enter a defined location. User contextual data, such as crossing fence boundaries, exiting a vehicle, exiting a transit station, user routines, sensor data, application data, etc., may be analyzed to predict that the electronic device is a threshold distance from a defined location and that the mode for electronic device should be adjusted.

In an embodiment, events monitor module 264 may detect from user contextual data that the user is in a remote location (e.g., wilderness), on an unfamiliar route, and/or unlikely to charge their device for an extended period of time. For example, a variety of signals from user contextual data may indicate that the user will be unlikely to charge their device, such as application data indicating a user tracking a workout, a maps application with a hiking path selected for display, a loss of cellular service, and/or any other data accessible on the device that provides context for activities of a user. In another example, the user may select a mode that indicates the user will not be able to recharge the electronic device 102.

The visit monitor module 270 may utilize event monitor module 264, fence information 290, and entry detection module 266 to accurately detect entry to a defined location and reduce latency for provision of positioning information by predicting the user will request the positioning data. The visit monitor module 270 may retrieve fence information 290 to define a more precise boundary for a defined location when the electronic device 102 is detected crossing a more coarse-grained geofence boundary, as detected using the entry detection module 266. In another embodiment, the visit monitor module 270 may retrieve expected sensor data (e.g., fingerprint data) characteristic of an electronic device 102 with the location status.

The proactive services 268 may be used to predict what applications and/or services that the user may want to access with a given user context, motion classification, and/or location status. For example, the user may want to access a particular application just prior to or upon entry to a location. Proactive services 268 may select applications based on user history of application selection or suggest a new application associated with a particular defined location.

In an embodiment, the electronic device 102 (with the event monitor module 264) may detect a set of conditions that allow for an inference that user may request a backtrack route to allow for retracing their steps and the electronic device 102 may initiate an extended power saving mode to obtain the positioning information so as not to affect the performance of the electronic device 102. In an embodiment, proactive service 268 may adjust a rate for periodic requests for determining positioning information. To handle intermittent receipt of positioning information, a machine learning model 240 may be used to reconstruct a path from user accessible data and estimate a distance for the path taken by the user.

In some embodiments, map data accessed by a mapping application 250 is used to estimate distances. The mapping application is an application that uses maps delivered by a geographic information system (GIS). The navigation application 220 may provide heading or direction (e.g., degrees from magnetic north) information for the electronic device 102 that is collected as the user is traveling, and the heading data is averaged to eliminate errors in heading information collected due to variations in heading measurements collected due to movement of the device (e.g., jostling of device, swinging of hand if device worn on wrist of user, etc.) as the user travels along their trajectory.

Proactive services 268 and event monitor module 264 may use a motion classifier 280, density classifier 282, and a backtrack classifier 278. A motion classifier 280 that has been trained on a feature set from data obtained using electronic device sensors may provide information on whether electronic device 102 is stationary or in transit with a user. While embodiments are not limited to a specific sensor type, specific sensor data representations, or specific features, exemplary sensors, and features are described herein that are capable of distinguishing between specific movements within the sensor data. The motion classifier can analyze provided features from sensor data using one or more models that are trained to perform identification of motion type based on the supplied features. In some implementations, the electronic device can receive motion classification from the electronic device or from a server indicating that the mobile device is traveling in a particular mode of transport. The backtrack classifier 278 classifies obtained historical positions for the mobile device 102 as potentially part of a backtrack route for a user of the electronic device 102.

A density classifier 282 that has been trained on a feature set from data obtained using electronic device sensors may provide information on the density of structures and/or population for a given geographic area. Features considered when classifying the geographic area include, but are not limited to, the following: wireless access point density, radio frequency signal (e.g., Bluetooth, UWB, etc.) density information, and/or map data on density and landscape to provide information on whether electronic device 102 is in a dense or a sparse geographic area.

### II. Complications and Waypoints

Locations services in an electronic device (e.g., a wearable device) may be accessible through a user interface that includes complications displaying information for corresponding applications. When certain complications (e.g., corresponding to a navigation application) are activated, waypoints can be displayed as icons.

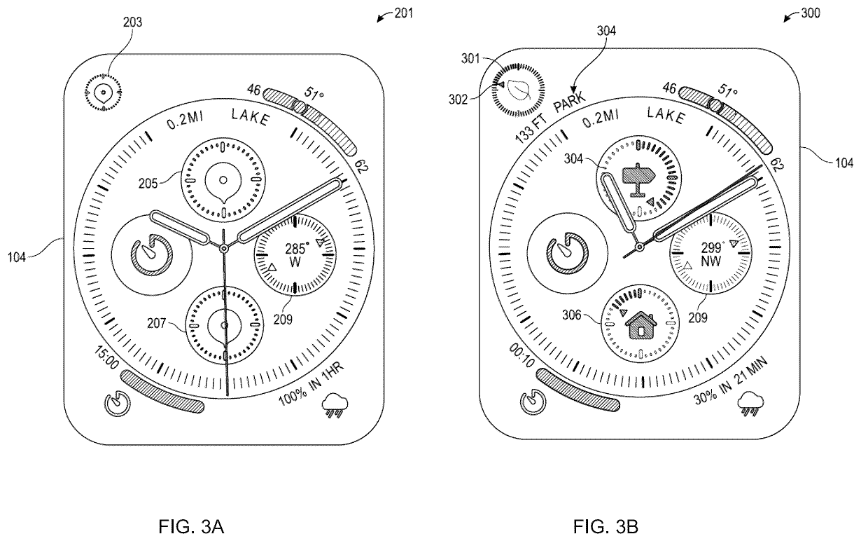

FIG. 3A depicts a user interface 201 for location services in accordance with an embodiment. The user interface 104 depicted is a smart watch face with location services complications 203, 205, 207, and 209. A “complication” is an object on a watch face that represents and displays information for an application and does not tell time, such as a date, weather information, atmospheric pressure, calendar information, a navigation application 220, a waypoint, etc. A particular complication corresponds to a particular application (e.g., navigation application) that may be executed on the device displaying the watch face. The complication can be displayed within a particular “style window” of a watch face. A “style window” can correspond to a part of a watch face that is designated to display the complication. In some embodiments, a user can configure a watch face by determining which information (e.g., by selecting a watch application) is to be displayed in a particular style window. As used here, the term “affordance” refers to a user-interactive graphical user interface object that can optionally be displayed on the display screen of electronic device 102. For example, an image (e.g., icon), a button, and text (e.g., hyperlink) can optionally each constitute an affordance.

The complications 203, 205, and 207, as illustrated, are deactivated and the corresponding application (e.g., navigation application 220 with waypoints) is not servicing requests for the deactivated complications on the electronic device 102. As illustrated, the deactivated complications 203, 205, and 207 may be greyed out with a particular shading to indicate that the navigation application 220 is not servicing requests for the complication. The complications 203, 205, and 207 represent navigation applications 220, and upon selection of the affordance corresponding to the respective complication, the bearing information is provided for a user selected waypoint position. For a dynamic waypoint complication, the user may be presented with a dialog (e.g., user interface) to select a waypoint position for the complication to be displayed on the watch face upon activation. For a static complication, the waypoint position may have already been assigned for the complication or the complication is predefined, and the navigation application 220 may provide bearing information for the respective waypoint. By way of example, a predefined or default complication may be for a car position and/or a home location. In another example, a user may select waypoints for a campsite and/or a park that may have been defined when the user was hiking and the user may want to select the waypoints to find their way back. In another example, complication 209 is activated and displays bearing information from true north for the electronic device 102 using the navigation application 220.

In some embodiments, the complications can be activated by interacting with the affordance representing the complication. For example, if the user selects the affordance representing complication 203 for the “Park” waypoint FIG. 3A, then the navigation application 220 services requests for the waypoint information (e.g., direction to the “Park” waypoint 302 and distance to waypoint 304 in the activated complication 301) and the information is displayed in activated complication 301 in FIG. 3B corresponding to deactivated complication 203 in FIG. 3A.

FIG. 3B depicts a user interface 300 for location services in accordance with an embodiment. The user interface 104 depicts activated complications: 301 (corresponding to deactivated complication 203 in FIG. 3A), 304 (corresponding to deactivated complication 205 in FIG. 3A), 209, and 306 (corresponding to 207 in FIG. 3A). In some embodiments, icons (as shown with a leaf icon 302, a house icon 306, and a sign icon 304 in activated complications) for waypoints are predefined (e.g., a car icon for a parked car, a house icon for a user's home or a campsite 306, a leaf icon for a park location 301, etc.) or assigned by the user (e.g., a sign with a particular color 304).

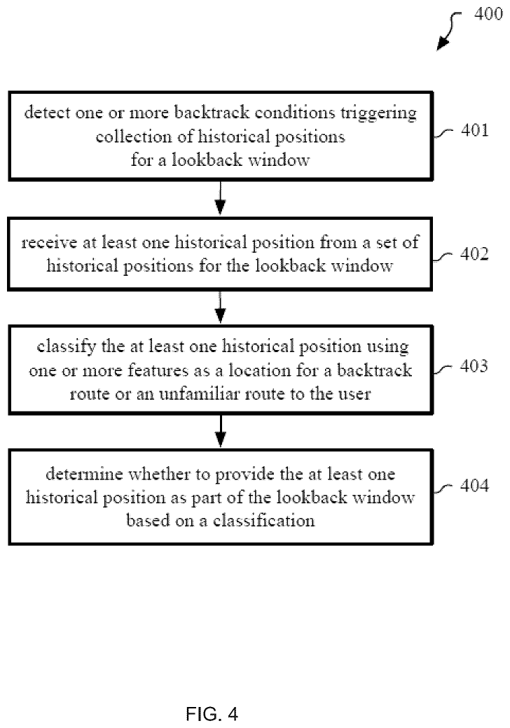

As shown in complication 301, the navigation application 220 provides the bearing information by displaying marker 302 within the complication to represent how far to the right the waypoint position is for the “Park” waypoint 301 from the user's current position. After the complications are activated, the complications may be updated with information for requests at a first time period (e.g., every 15 minutes), but the frequency may decrease or increase based on the motion classification and/or mode of transport. For example, complications 304, 209, and 306 may be serviced by duty cycled requests operating at a first time period (e.g., every 15 minutes), and complication 301 may be serviced with requests that occur at a first time interval value (e.g., every 1 second) because the user is moving toward the waypoint. In some embodiments, if the user selects affordance (e.g., with a long press on the screen) complication 301, the user interface for a targeted view of the waypoint may be provided, as shown in FIG. 4.

### III. Backtracking

Embodiments provided herein describe obtaining positioning information from a global navigation satellite system (GNSS), such as a global positioning system (GPS), when one or more backtracking conditions are met. One or more backtracking conditions are a set of conditions that allow for an inference that a user is on a route that is unfamiliar, in the wilderness, part of an exercise session, unable to recharge their device for an extended period of time, and/or engaging in any other activity that may require retracing the steps taken on the route. Based on the set of backtracking conditions that are observed, a prediction is made that a user may need historical positioning information to be able to retrace their steps with the backtrack route and request the electronic device proactively obtain the historical positioning information. The backtrack route may be the set of historical positions obtained over a lookback window of time that allows the user to retrace their steps. The lookback window is the set of historical positions over an immediate period of time that are likely to be needed in order to retrace their steps while preserving the privacy of the user from a bad actor seeking more than the recent backtrack route. In some embodiments, the lookback window of positions returned upon request is adjusted (e.g., truncated, pruned, etc.) to provide positioning information only pertinent to the immediate need for the backtrack route.

Embodiments described herein provide a backtrack classifier that classifies obtained historical positions upon request for the electronic device as a candidate position or not a candidate position in the backtrack route for a user of the electronic device. In an embodiment, historical positions are classified to find the most recent historical position from which the backtrack route may be needed. The historical positions designated as part of the backtrack route may be provided to a location services application upon request to aid the user in retracing their steps, potentially when lost and/or request aid in an emergency situation.

Because non-stop or continuous collection of positioning information may drain resources (e.g., battery, processor usage, etc.) when a user is unable to recharge their device (such as while in the wilderness or lost), the electronic device may obtain position information in a power conserving extended mode when one or more backtrack conditions are met.

In an embodiment, the one or more backtrack conditions may include, but are not limited to, the following: in transit (e.g., not stationary) motion classification, threshold period of time without network access, sparse (e.g., not densely populated or density of manmade structures in the area, etc.) environment classification, and threshold distance from a frequented location and/or location that is part of a user routine. While specific categories of conditions are provided, those with skill in the art will recognize that any other user contextual data may supplement and/or form the basis of an inference that the user will request historical positioning information for backtracking.

FIG. 4 is a flow chart 400 illustrating a backtracking approach, according to an embodiment. The electronic device 102 detects one or more backtrack conditions that trigger collection of a set of historical positions for a lookback window of time (401). The one or more backtrack conditions are the set of conditions determined by analyzing user contextual data that allow for an inference that the user may need backtracking historical positioning data (e.g., is in the wilderness and/or in an unfamiliar area). The electronic device 102 predicts based on the one or more backtrack conditions that a user may want the historical position information to allow for backtracking (e.g., retracing route) in the navigation application and/or mapping application. In some embodiments, the one or more backtrack conditions detected are a subset of conditions that may be determined from analysis of accessible user contextual data as indicated in FIG. 3 with the extended mode. Although a particular approach is described for collection of historical positions, the set of conditions for inferring that a user is lost prior to collection of historical positions and the subsequent review of conditions before responding to a request for historical positions may be practiced with any implementation for collection of historical positions.

User contextual data may supplement the backtrack conditions to provide in a decision to initiate the extended mode and obtain positioning information. In an embodiment, the one or more backtrack conditions may include, but are not limited to, the following: in transit motion classification (e.g., not stationary), threshold period of time without network access, sparse environment classification (e.g., not densely populated or density of manmade structures in the area, etc.), and beyond a threshold distance from a frequented location and/or location that is part of a user routine. While specific categories of conditions are provided, those with skill in the art will recognize that any other user contextual data may supplement and/or form the basis of an inference that the user will request historical positioning information for backtracking.

The motion type classification condition is met if the electronic device 102 receives a motion classification of not stationary and/or is “in transit.” In an embodiment, the motion type classification condition is met if the mode of transport is a human-powered (e.g., on foot, a bicycle, a skateboard, etc.) or motor-assisted vehicle (e.g., a motor-assisted bicycle) and not a motorized vehicle or automotive vehicle (e.g., car, airplane, electric vehicle). A motion classifier 280 that has been trained on a feature set from data obtained using electronic device sensors may provide information on whether electronic device 102 is stationary or in transit, including a mode of transport. In some embodiments, the motion classification may indicate an inference of the activity or mode of transport for the user while in transit, including, but not limited to, the following: walking, on a bicycle, on exercise equipment, on a scooter, on a skateboard, within a vehicle, on an airplane, on a transit vehicle, on a train, on a subway, human-powered vehicle, motor-assisted vehicle, electric-assisted vehicle, automotive vehicle, and/or any other motion classification.

The network access backtrack condition is met if the electronic device 102 is not in communication range to a wireless access point in a geographic area (e.g., internet access, WiFi, cellular network access points, etc.) or the geographic area has a relatively lower access point density as compared to a defined access point density threshold. The electronic device 120 can, for example, conduct one or more wireless surveys to probe the geographic area for the presence of wireless access points while the device is in transit for a span of time. For example, the electronic device 120 can continuously, periodically, or intermittently search for wireless signals transmitted using one or more frequency bands designated for wireless communications. If the observed number of access points is lower than the defined access point density threshold for the span of time, then the network access backtrack condition is met.

The electronic device 102 determines if the type of environment backtrack condition is met based on a classification for the geographic area as having a sparse density of structures in the geographic area using the density classifier 282. The density classifier 282 that has been trained on a feature set from data obtained using electronic device sensors may on wireless access point density, radio frequency signal (e.g., Bluetooth, UWB, etc.) density information, and map data on density and landscape to provide information on whether electronic device 102 is in a dense or a sparse geographic area. In some embodiments, the density of wireless access points in the region is a feature provided in the classification for the density of structures in the geographic area. For instance, if there are a large number of different wireless access points per area, then there is a higher likelihood of a dense urban environment. As another example, the time span recorded between observations of wireless access points may be a feature provided to the density classifier 282 and serve as an indicator for a sparse environment. In some embodiments, a map tile service can provide a tile-based mapping service to the electronic devices 102 that enables the electronic device 102 to retrieve map data and metadata for a geographic region of the electronic device 102 or a region that is being searched by the electronic device 102. The map tile metadata can be retrieved from a remote map tile database or a local (e.g., cached) subset of the map tile database. The metadata can include a classification of the current map tile or sub-tile. The map tile metadata can also include digital elevation model (DEM) data that indicates a surface model including structures for the estimated geographic region and can be a feature for the density classifier 282.

Next, if the electronic device 102 is beyond a threshold distance from a frequented location, a location that is part of a user routine, a safe or trusted location, then the backtrack conditions met may be analyzed to determine if enough conditions are met to proceed with proactively obtaining historical positioning information.

If enough backtracking conditions are satisfied, then the electronic device 102 receives at least one historical position from a set of historical positions for the lookback period of time (402). Although described with reference to classification of a single historical position, those with skill in the art will recognize that a plurality of historical positions may be classified to determine the lookback window of historical positions to include in the backtrack route.

The electronic devices may classify the at least one historical position as a candidate position for a backtrack route based on one or more features (e.g., signals) observed at the time of collection for the historical position (e.g., duration of lookback window, no location further than 250 km, no locations before in vehicle, etc.) (403). Features considered when classifying the historical position include, but are not limited to, the following: duration of time included in lookback window, distance from a frequented, safe, and/or trusted location, position information collected prior to and after entry of a motorized-vehicle (e.g., automobile, airplane, etc.) and/or electric-vehicle, density of structures classification (e.g., urban area, etc.), access point density, motion classification, mode of transport classification, user activity (e.g., hiking event from calendar data), and/or any other feature that may indicate a user may need a backtrack route.

By way of example, the most recent historical position considered as a lookback window candidate may not as far back in the past as a max duration from a current time. Similarly, historical positions that are greater than a max distance from a current position may be excluded from consideration as a candidate for the lookback window. Position information acquired during a flight and/or other trip within a vehicle may be truncated from the lookback window and deemed not a candidate for the lookback window. In some embodiments, unless the user requests recording of historical positions near a frequented location and/or safe, trusted location, then the historical positions not beyond a trusted threshold distance may be truncated from the lookback window. An access point density and density of structures classification indication that the user may be in an urban location may allow for truncating the lookback window with associated positions. The features described are examples and any number of the described features may or may not be used by the backtrack classifier 278 to determine the lookback window.

The electronic device 102 determines whether to provide the at least one historical position as part of the lookback window based on a classification (404). In an embodiment, the classification of historical positions in the lookback window begins from a prior classified historical position in the lookback window and the classification continues until a most recent candidate is identified. The historical positions prior to the most recent classified candidate may be purged. By selectively providing historical locations when conditions suggest that the user is lost, bad actors are prevented from accessing and/or causing the exposure of prior locations for a user that may be against the user's own interest.

In some embodiments, the application requesting access to the lookback window must possess an entitlement. The entitlement may identify the application as having a right or a privileged to access positioning information. If the user requests via an application access to historical positioning information, then the lookback window positioning information may be provided opportunistically as opposed to requiring the user to request duplicate efforts to obtain historical positioning information.

### IV. Tracking Last Known Location for Network Signal

Embodiments provided herein describe automatically generated waypoints for tracking the last known locations with wireless network signals. The time and location information related to these waypoints may be stored in a secured storage/database with privacy safeguards. When a user of a mobile device in a non-urban location state launches a navigation application (e.g., compass application or map application), a backtrack route to one or more of these waypoints can be displayed on the mobile device.

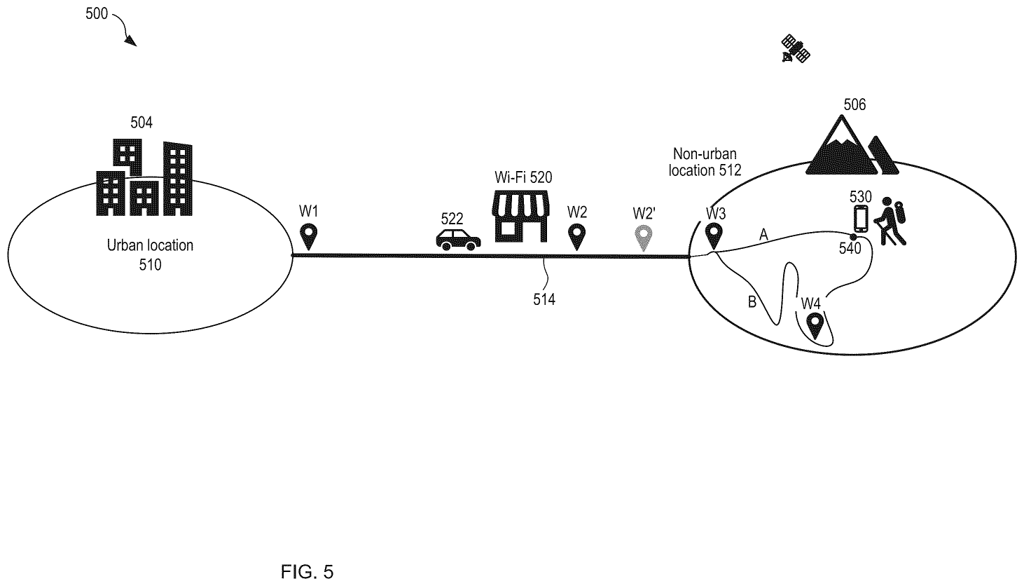

FIG. 5 is a diagram illustrating waypoints for the last known network connectivity and backtracking, according to some embodiments. FIG. 5 shows an urban location 510 and a non-urban location 512. An urban location may have many building structures, network wireless signals (e.g., cellular connection and Wi-Fi), and motion activities using motor-assisted vehicles. A non-urban location may be in a remote area with few building structures, spotty network wireless signal, and human-powered activities (e.g., biking, running, hiking). A user of a mobile device 530 may travel from the urban location 510 to the non-urban location 512 through a country road 514 with a few rest places (e.g., 520).

In FIG. 5, a few waypoints (e.g., W1, W2, W3, and W4) may be marked along the path that the user of the mobile device 530 travel. For example, waypoint W1 is just outside the urban location 510 and may have a cellular connection. W2 is after a rest place 520, which has a Wi-Fi signal. W3 and W4 are inside the non-urban location 512. W2′ may or may not exist during a transition from an urban location to a non-urban location. Waypoint W4 may be created if the user takes route B instead of route A. Further details about the waypoint creation are described below.

When the user of the mobile device 530 in a particular non-urban location 540 tries to make a communication (e.g., a phone call or text message) but no network wireless signal is available, the techniques or embodiments disclosed in the present disclosure may allow the user to find a path to backtrack to a last known location (e.g., W3 or W4 of FIG. 5) with a network connection that has adequate network wireless signal (e.g., either a cellular internet connection or a SOS connection) for sending an emergency message or making an emergency call. In some embodiments, the user may launch an application, such as a compass application or a map application, on a user's mobile device (e.g., a mobile phone, a watch, or a companion device). The launched application may access a secured database (or storage) and determine whether the user has permission to access certain waypoint information (e.g., historical information related to time, locations, signal strength, signal type, etc.) based on the user's status (e.g., a non-urban location state), and then display a backtrack path from the current location to a previous location (i.e., a waypoint) with adequate network wireless signal strength (e.g., above a threshold) for making the communication.

### A. Creation of Waypoints

As discussed above, waypoints can be automatically created for tracking the last known locations with wireless network signals. In some embodiments, the techniques disclosed in the present disclosure can automatically create two types of system waypoints: a cellular waypoint for tracking cellular connectivity and an SOS waypoint for tracking SOS connectivity. SOS is common name of the international Morse code distress signal. A SOS connectivity may refer to a network wireless signal allowing a user to send an emergency message or make an emergency phone call. The network wireless signal for SOS purposes may include, but is not limited to, an in-network signal provided by the user's subscribed wireless carrier, an out-of-network signal provided by other wireless carriers, and a satellite signal. In some countries, for example, U.S., Canada, and Australia, a user can make a cross-carrier emergency call. On the other hand, cellular connectivity typically refers to the in-network signal provided by the user's subscribed wireless carrier.

In some embodiments, a mobile device employing the disclosed techniques can track all types of network wireless signals, and automatically determine which type of waypoint to create, and create accordingly. For example, a cellular waypoint is automatically created when an in-network cellular signal goes below a threshold. An SOS waypoint is automatically created when out-of-network signals and/or a satellite signal drop below a threshold.

In certain embodiments, the signal reception, including its strength, of both types of network wireless signal (cellular and SOS) is continuously monitored and tracked. The signal strength may be saved into a database in various representations, such as a bit flag indicating that the signal was above or below the threshold or a numerical value. For example, a signal strength may be saved as one, two, or three bars. In another example, the signal strength may be saved as numerical value, 1, 2, or 3.

Every time the signal strength drops below a threshold (e.g., two bars or value 2), the location services may create a waypoint (either a cellular waypoint or SOS waypoint), such as waypoints W1 to W4 of FIG. 5, on the path that the user travels. In other words, the waypoint indicates that a cellular or SOS network wireless signal may be above the threshold for communication right before the marked location on the path. For example, a user of a mobile device may be hiking on a trail above a hill with a cellular connection. At one point, the signal strength of the user's in-network wireless signal drops below two bars, and the user's mobile device may automatically generate a cellular waypoint (e.g., waypoint W3 of FIG. 5) on the path of the user's hiking trail. When the user wants to make a phone call but finds no signal is available or is too weak, the user may launch an application to find the way back to the cellular waypoint with adequate signal strength. On the other hand, if the signal strength goes back or recovers above the threshold, no waypoint is created because the user does not need to use this waypoint feature and can just use the mobile device to communicate. In some embodiments, several cellular or SOS waypoints may be created when the signal strength drops and recovers more than once.

### B. Waypoint Information Database and Privacy

As mentioned earlier, information related to waypoints may be stored in a secured storage/database with privacy safeguards. As part of the privacy safeguards, time and location information may be stored separately, and a location state (e.g., urban, or non-urban) of the mobile device may be determined for information access and display purposes.

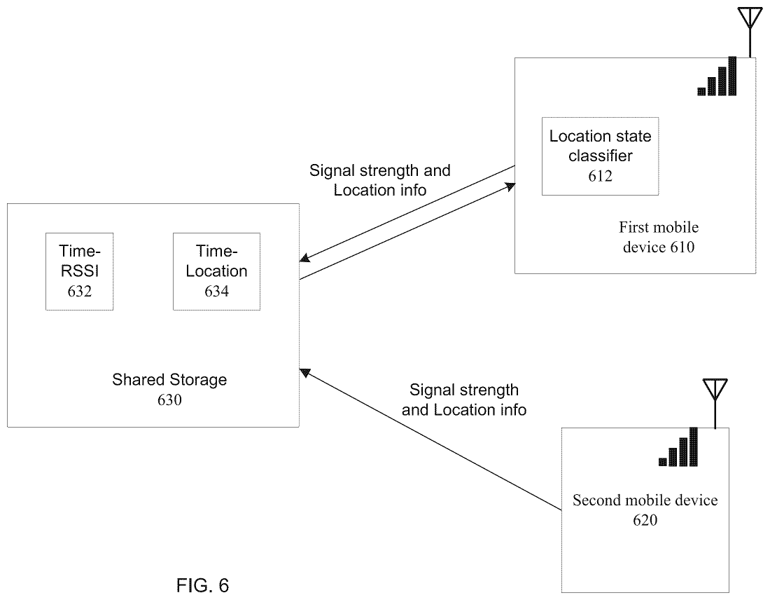

FIG. 6 shows a diagram 600 for providing location information about when a network signal was last available, according to an embodiment. In FIG. 6, diagram 600 includes a secure storage 630, which further includes two tables or databases, a first table/database 632 and a second table/database 634. In some embodiments, the secure storage 630 may contain a single database partitioned into two securely isolated portions. The secure storage (or database) 630 may be shared by multiple mobile devices. As shown in FIG. 6, two mobile devices, a first mobile device 610 (e.g., a wearable device) and a second mobile device 620 (e.g., a mobile phone), access the shared secure storage 630. The first mobile device 610 may further include a location state classifier 612. The location state classifier may classify the location state (e.g., urban location or non-urban location) of the first mobile device 610. Further details describing the classification process are described below.

In some embodiments, the signal strength may be saved in the secure database (or storage) 630 shared between mobile devices of a user, such as mobile phone, watch, or other companion devices. These companion devices can communicate with each other locally, such as by using Bluetooth, even without a cellular signal or internet. The shared storage can be synchronized between the companion devices, such that when one mobile device is unavailable, for example, due to lack of power, another mobile device can still access the shared storage.

Besides the signal strength, the shared secure storage (or shared database) may also contain other waypoint information including, but not limited to, time, locations, signal strength, cellular state (e.g., connected, disconnected, roaming, airplane mode), motion classification (e.g., driving, running, walking, stationary, etc.), sequence or order of events (e.g., driving then walking, or in-network connection followed by out-of-network connection), network wireless signal type (e.g., cellular or SOS), map tile category, and altitude, although only signal strength and location information are shown in FIG. 6. The waypoint information may be saved for a period of time (e.g., ranging from a week to a month) before new information can overwrite previously saved old information.

In some embodiments, one of the mobile devices can store the waypoint information into and retrieve it from the shared storage while another can only store the waypoint information into the shared storage. For example, in FIG. 6, the first mobile device 610 may be a wearable device, such as a watch, and can store signal strength and location information into the shared storage 630, and retrieve the stored location information for location state classifier 612 to analyze and use. The second mobile device 620 may be a mobile phone, a companion device of the first mobile device 610, can also store signal strength and location information into the shared storage 630, when the first mobile device 610 has a weak signal or lack power.

In some implementations, for privacy purposes, two tables can be used to store the signal strength (e.g., received signal strength indicator (RSSI)) and location separately. For example, in FIG. 6, when two tables are used, storing a previous location (e.g., a cellular waypoint or an SOS waypoint, such as W3 of FIG. 5) can include storing, in a first table 632, strength information of the network wireless signal at one or more times (depicted as time-RSSI), and include storing, in a second table 634, locations of the first mobile device at the one or more times (depicted as time-location). The shared storage 630 may be synchronized between the first mobile device 610 (e.g., a watch) and the second mobile device 620 (e.g., a mobile phone) of a user.

In some embodiments, access to the second table 634 of the secure storage 630, storing location information at one or more times, is accessible only by certain system routines, which can provide such information to a user only when certain criteria are met, for example, location type is one where the signal is likely to be lost, such as in a non-urban location state. As an example, if a user loses cellular connection at 1 PM in an urban location (e.g., San Francisco or 510 of FIG. 5), the compass application launched by the user may not access the second table storing location information. However, at 2:30 PM, the user lost cellular connection again on a hiking trail (e.g., 540 of FIG. 5). The location services (including location state classifier 612) may allow the compass application launched by the user to access the second table 634 for the location information, for example, using a timestamp to make an API request to retrieve location information from the second table.

As shown in FIG. 6, the first mobile device 610 can use a location state classifier 612 of the location services to determine whether to provide a previous location (e.g., a cellular waypoint or an SOS waypoint) to the user. For example, location state classifier 612 can determine whether the first mobile device is within a non-urban location state. In this manner, the location information can only be exposed when it is likely needed; for example, the user needs to make an emergency call in an area where the signal is lost or sparse. In such a situation, the previous location can be retrieved based on the location (e.g., W3 of FIG. 5) being a non-urban location state. In other words, the location information is continuously and periodically tracked, but the access to the location information may be restricted.

In addition to the non-urban location state determination for accessing the location information, the location services may place a limit (or threshold) on how far back in time the stored location information in the secured storage 630 can be accessed based on the historical information. The access limit may be the earliest time when the mobile device is considered to be in a non-urban location state. For example, continuing with the above example, in FIG. 5, when the user of the mobile device 530 on the hiking trail 540 launches the compass application at 2:30 PM. The location services may perform a check to determine whether the user is in a non-urban location state. The location services additionally checked the logged historical information and found that the user was driving (e.g., 522) at 1:30 PM with a cellular connection before waypoint W2 of FIG. 5 and was in an urban location (e.g., waypoint W1 of FIG. 5) at 1 PM. As a result, the compass application may be allowed to access the second table 634 with location information for only up to 1:30 PM (or up to waypoint W2 of FIG. 5) because driving is a motion state considered less likely to be in a non-urban location state.

Furthermore, after the compass application accesses the secured storage 630, it may display a backtrack route to a waypoint position (e.g., a previous location associated with the most recent waypoint or closest waypoint) with a cellular connection (i.e., cellular waypoint) or SOS connection (SOS waypoint), but not the path beyond that waypoint position because the limited access to location information in the second table 634. For example, the path from point 540 to waypoint W3 (route A) or W4 (route B) of FIG. 5 may be displayed, but not the path from waypoint W3 to W2. As a result, only some, not all, of the historical paths from where the user travels with the mobile device are displayed as needed.

In other words, the location services ensure two things when the compass application requests database access: first, the user is in a non-urban location state, and second, the database access for location information is only available back in time to the point the user location state changed from urban to non-urban. In this manner, the information about the locations is only provided when needed and enough for use, thereby reducing the chances such location information could be misused.

In some embodiments, if the user has reached the displayed waypoint position (e.g., W3) that has previously recorded with adequate signal strength (i.e., above the threshold), but the signal strength has changed, for example, weaker than previously recorded such as due to weather condition, then another backtrack route from W3 to W2′ (or W2) may be displayed, provided that the mobile device is still in the non-urban location state. In other words, the display of backtrack routes (and access to location information in the secure storage 630) may be performed in stages.

In further embodiments, all cellular/SOS waypoints within the non-urban location state may be displayed, but other waypoints during the transition between an urban location state and a non-urban location state are displayed in stages (i.e., staged display). For example, in FIG. 5, waypoints W4, W3, and W2′ (if determined to be in the non-urban location state) may be displayed when the mobile device is in the non-urban location state. Waypoint W2 is not displayed until the user of mobile device reaches W2′ waypoint position, and W2 is needed due to weak signals at W2′. Further details about the backtrack route display are described below.

### 1. Location State Classification

Location state classification refers to determining a location category (e.g., urban, or non-urban) that a mobile device belongs to. The location category may be used as part of the privacy safeguards discussed earlier.

In some embodiments, determining a mobile device (e.g., the first mobile device 610) is within a non-urban location state by the location state classifier 612 can use one or more of:
(1) detectability of network wireless signals, such as in-network signal, out-of-network signal, or other types of wireless signals, including satellite signal and Wi-Fi signals, at the time or at earlier times than the time when waypoint information is requested;
(2) one or more motion states (e.g., walking, running, biking, driving, stationary, etc.) of the first mobile device 610 at the time or at the earlier times, and
(3) a classification of one or more map tiles within which the first mobile device 610 resided at the time or at the earlier times. A map tile may be generated by a tile-based mapping service that can retrieve map data and metadata for a geographic region around a mobile device based on GPS information.

For example, when the first mobile device 610 requests to access waypoint information stored in the shared storage 630, the location state classifier 612 may determine the location state of the first mobile device, using network wireless signal, motion state, map tile, and a combination of one or more of these information. For location state determination, as an example, the detection of a network wireless signal, such as a Wi-Fi connection (e.g., 520 of FIG. 5), may indicate that a mobile device is in an urban location state. However, in certain embodiments, when network wireless signals are spotty, resulting in many waypoints created in a short distance, for example, an additional waypoint W2′ that is only one mile away from waypoint W2 is created, the location at waypoint W2′ may be determined to be in non-urban location state. Thus, network wireless signals detected at the time or before the waypoint information is requested can help determine the location state of the mobile device.

As another example, a motion state or classification such as driving (e.g., 522 of FIG. 5) is more likely to be in an urban location state, while walking, biking, or running, is more likely to be in a non-urban location state. The motion state shortly before the waypoint information is requested can help determine the location state of the mobile device because the user of the mobile device may stop its activity to make the request.

Yet, for another example, the classification of one or more map tiles within which the mobile device resided may indicate a non-urban location (e.g., 512) state because of no building structure (e.g., 504) in the geographic region covered by the map tile(s) or high altitude (e.g., 506). As mentioned earlier, a map tile may be generated by a tile-based mapping service. A map tile can be a geographic region covering the mobile device, where the region may be a square with roughly five to ten miles in length for each side, or in other shapes (e.g., rectangular, circle, hexagon, etc.). In some embodiments, the size of the geographic region may vary depending on the location state. For example, the size of geographic region may be smaller for an urban location, such as five mile in length, because more data, such as buildings, streets, highways, parks, etc. is associated with a tile. The size may be larger for a non-urban location, such as 50 miles or more in length, if the landscape has little changes. The map tiles may be cached in the secured storage/database for the mobile device at any time when network wireless signal and power are available for such service. In some embodiments, the map tile may also include altitude information. In some embodiments, the signal strength and motion state may be pre-computed and incorporated into the tile-based mapping service to generate map tiles.

### C. Display Waypoint Positions and Backtrack Routes

As discussed earlier, as part of backtracking, a backtrack route (or a path) from the current location (e.g., 540 of FIG. 5) of a mobile device to the latest (or the most recent or the last created) cellular/SOS waypoint (e.g., waypoint W3 for route A of FIG. 5) may be displayed on a requesting user's mobile device (e.g., 610 of FIG. 6). Sometimes, the most recent waypoint is also the nearest (or closest in distance) to the current location. At other times, the more recent waypoint and the nearest waypoint may be different. For example, in FIG. 5, if a user travels in a relatively straight line (e.g., route A), the nearest cellular waypoint and the most recent cellular waypoint are the same, which is waypoint W3. On the other hand, if the user travels on a winding road (e.g., route B), the nearest cellular waypoint (e.g., W3) and the most recent cellular waypoint (e.g., W4) can be different. In such a situation, multiple waypoints (e.g., both the nearest and most recent cellular waypoints) with a path to each may be displayed for the user of the mobile device 530 to select, thereby helping the user choose an easier or faster route to reach a waypoint. In certain embodiments, the backtrack routes may be displayed in three dimensions, including the elevation of the waypoint to indicate the terrain of the routes.

In other embodiments, a set of previous locations (or waypoints) within the non-urban location state may be retrieved. A path between a current location (e.g., 540 of FIG. 5) and the first cellular/SOS waypoint determined to be in the non-urban location state (e.g., assuming waypoint W2 is determined as a non-urban location) may be displayed. The other waypoints (e.g., waypoints W2′, W3 and W4) may be included in the displayed path.

A cellular/SOS waypoint can be displayed with an icon or text indicating that the waypoint was a previous location having an available network wireless signal. Other previous locations that are deemed urban location states, regardless of cellular connection, are not displayed.

After the first mobile device reaches a previous location (e.g., W3 or W4 of FIG. 5) with network connection (cellular or SOS), a message can be sent. The message can be an emergency message. The emergency message can be an emergency phone call.

### D. Process Flow For Providing Location Information

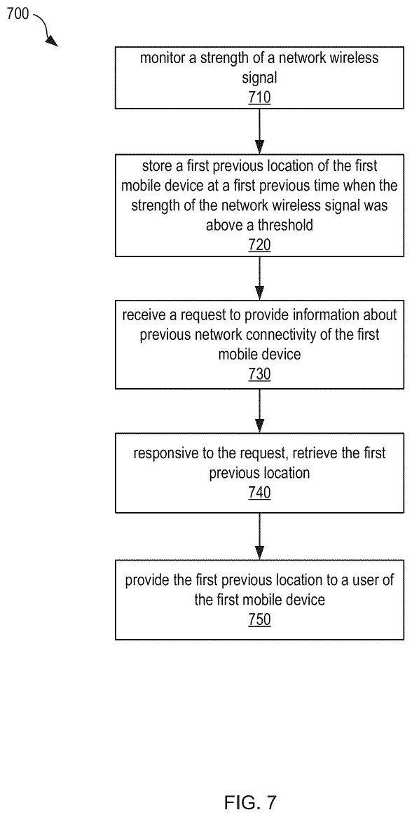

FIG. 7 is a flowchart illustrating a method 700 for providing location information about when a network signal was last available, according to some embodiments. In some implementations, one or more method blocks of the method 700 may be performed by one or more processors of a first mobile device. Additionally, or alternatively, one or more method blocks of the method 700 may be performed by one or more components of a mobile device, such as processor 1918 of FIG. 19. The first mobile device can be a wearable device (e.g., a watch).

At block 710, a strength of a network wireless signal is monitored. Such monitoring can use the same modules that measure the strength for display on a screen. FIG. 6 shows bars corresponding to network strength. The signal strength can be monitored using signals received by the first mobile device 610, at the second mobile device 620, or both. Thus, the strength of the network wireless signal can be monitored at a second mobile device that is in local communication with the first mobile device (e.g., paired via Bluetooth).

The network wireless signal can be for cellular connectivity or SOS connectivity. For SOS connectivity, the signal may be an in-network signal or an out-of-network signal (i.e., a different carrier than what the user of the first mobile device subscribes to). The cellular connectivity and SOS connectivity may overlap if the in-network signal is available. In some embodiments, these two different signals can have locations that are provided with different icons or text to a user.

At block 720, a first previous location of the first mobile device is stored at a first previous time when the strength of the network wireless signal was above a threshold. The first previous location can be measured using GPS. Storing the first previous location uses a shared storage/database (e.g., 630 of FIG. 6) between the first mobile device and the second mobile device. The first previous time may be the first time that a cellular or SOS waypoint (or the first previous location) is created in a non-urban location state when the network wireless signal changes from above a threshold to below a threshold. In other embodiments, the first previous time and the first previous location may be the time and location a cellular/SOS waypoint (e.g., the most recent waypoint or the closest waypoint) is created in a non-urban location state.

In some embodiments, as discussed above, the signal strength (RSSI) may be stored in a first table (e.g., 632 of FIG. 6) and location information may be stored in a second table (e.g., 634 of FIG. 6) for privacy purposes. Access to the location information in the second table may be permitted only when certain criteria are met, such as non-urban location state.

At block 730, a request to provide information about the previous network connectivity of the first mobile device is received. For example, when a user of a mobile device likes to make a communication (e.g., a phone call or text message) but no network wireless signal is available, the user may launch an application, such as a compass application or a map application, which automatically requests location services to obtain information about previous network connectivity, such as a cellular waypoint or an SOS waypoint.

At block 740, the first previous location is retrieved responsive to the request. For example, the location services may access the secure storage 630 to retrieve signal strength information from the first table 632, and location information from the second table 634 upon determining, by the location state classifier 612, that the first mobile device is in a non-urban location state. In some embodiments, a set of previous locations in a non-urban location state between a current location of the first mobile device and the first previous location (either a cellular waypoint or an SOS waypoint) may be retrieved.

At block 750, the first previous location is provided to a user of the first mobile device. For example, the compass application or map application may display a path (or backtrack route) from the current location to the first previous location. For example, in FIG. 5, a path from the current location (540) to the very first waypoint created (e.g., W2 of FIG. 5) in a non-urban location may be displayed along with other waypoints (e.g., W2′ and W3, and/or W4) in the path.

In some embodiments, for privacy, as discussed above, waypoints may be displayed in stages by displaying the latest (or the nearest) waypoint. Other waypoints created earlier than the latest waypoint may not be displayed unless needed. For example, in FIG. 5, if the user reaches the displayed waypoint (e.g., W3 of FIG. 5) but the signal strength at that waypoint has changed (e.g., weaker than previously observed), the location services may retrieve more location information from the secure storage 630 for the application to display next cellular or SOS waypoint (e.g., W2 or W2′ of FIG. 5) if the mobile device is still in non-urban location state.

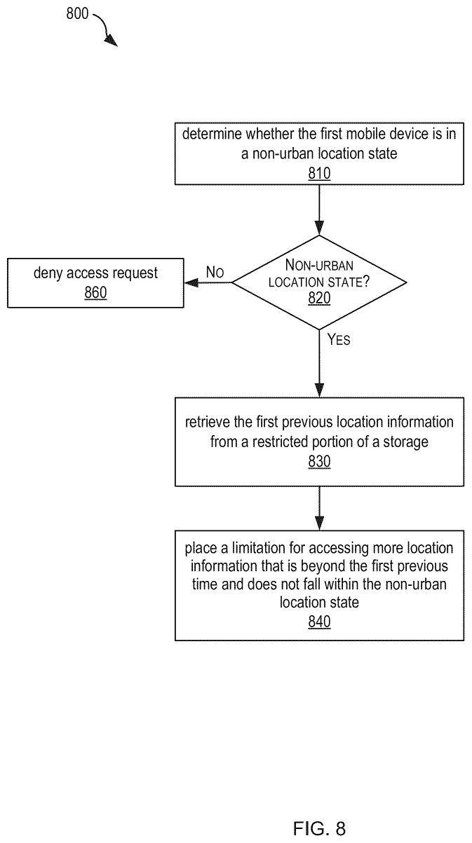

FIG. 8 is a flowchart illustrating a method 800 for providing location information with privacy safeguards, according to some embodiments. FIG. 8 describes further details in block 740 of FIG. 7.

At block 810, whether the first mobile device is in a non-urban location state is determined. As discussed earlier, a non-urban location state may indicate that network wireless signals are more likely to be lost. Thus, a user of the first mobile device has the need to access the location information of the first mobile device.

At block 820, if the first mobile device is in a non-urban location state, the processing proceeds to block 830.

At block 830, the first previous location information is retrieved from a restricted portion of a storage. For example, in FIG. 5, waypoint W2 may be retrieved from the second table 634 in the secured storage 630 of FIG. 6 containing the location information, which requires certain criteria to be met, such as in a non-urban location state.

At block 840, a limitation (or threshold) is placed for accessing more location information that is beyond the first previous time and does not fall within the non-urban location state. As discussed earlier, historical information (e.g., location information) beyond the time that is considered to be not in a non-urban location state may be restricted for privacy reasons. For example, in FIG. 5, information about waypoint W1 may be restricted for access because its associated time is determined to be in an urban location state.

Returning to block 820, if the first mobile device is not in a non-urban location state, the processing proceeds to block 860. At block 860, access requests to the secured storage for information fall outside a non-urban location state may be denied, and the corresponding waypoints cannot be displayed either. In some embodiments, the location services may further request identification information (e.g., biometric data, password, etc.) from the requesting user for access to safeguard the privacy.

### E. Accessibility of Waypoint Information and Backtracking Feature

Since the SOS/cellular waypoints and the backtracking (e.g., displaying backtrack routes to waypoints) features can help a user of a mobile device (e.g., wearable watch) when the user needs it most in a non-urban location, it would be beneficial to make the user aware of these features or make them discoverable at an appropriate time, and provide easy access when needed.

In some embodiments, when one or more SOS/cellular waypoints are available, and the user is determined to be in a non-urban location, a prompt may be displayed on the mobile device asking whether the user likes to see the information. For example, when the user tries to make a phone call or send a text message but fails, a notification or prompt can also be displayed asking whether the user would like to find an available service (e.g., cellular waypoint). Once the user answers the prompt and requests the information, the backtrack route display process described above (e.g., FIG. 7) will follow.

In certain embodiments, for some activities, such as hiking, running, or skiing, while the user is determined to be in a non-urban location, the backtracking feature may automatically start and prompt the user at the appropriate time.

In some embodiments, the backtracking feature may be started either manually or automatically. For example, if the user starts the backtracking feature manually before engaging in an activity, the backtracking feature may not stop unless the user stops it. However, if the backtracking feature starts automatically in a non-urban location as described above, the backtracking feature may end automatically if the user does not access the feature.

Finally, in certain embodiments, if the user turns on an application, such as a running application, during a live activity (e.g., running, biking, etc.), a compass application may become part of a smart stack, allowing easy access by the user if needed. A smart stack is a set of widgets that uses information such as the time, the user's location, and the user's activity to automatically display the most relevant widgets at the appropriate time in a day. The user may turn the digital crown on the mobile device (e.g., wearable watch) to access the compass app to use the backtracking feature.

### V. User Interface for Displaying Last Known Location for Network Signal

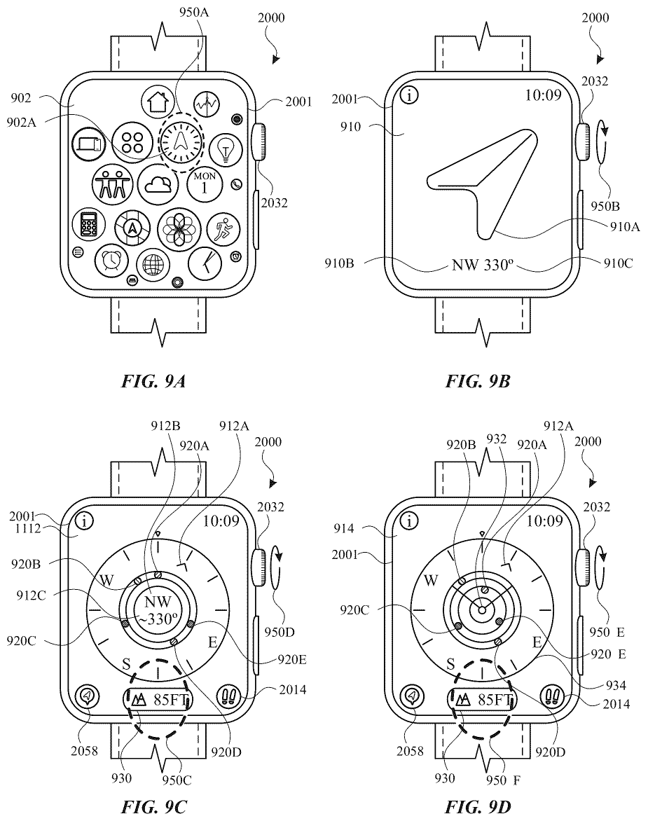

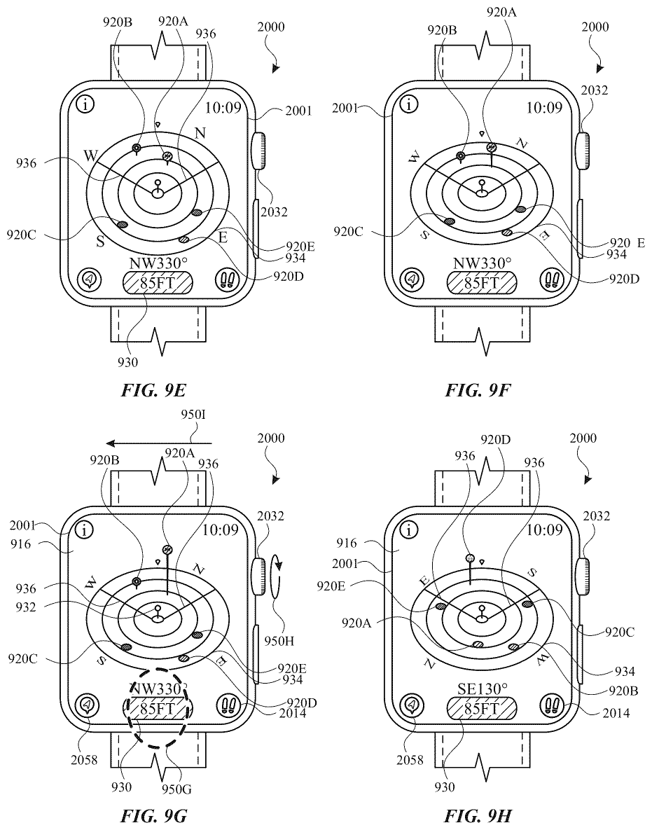

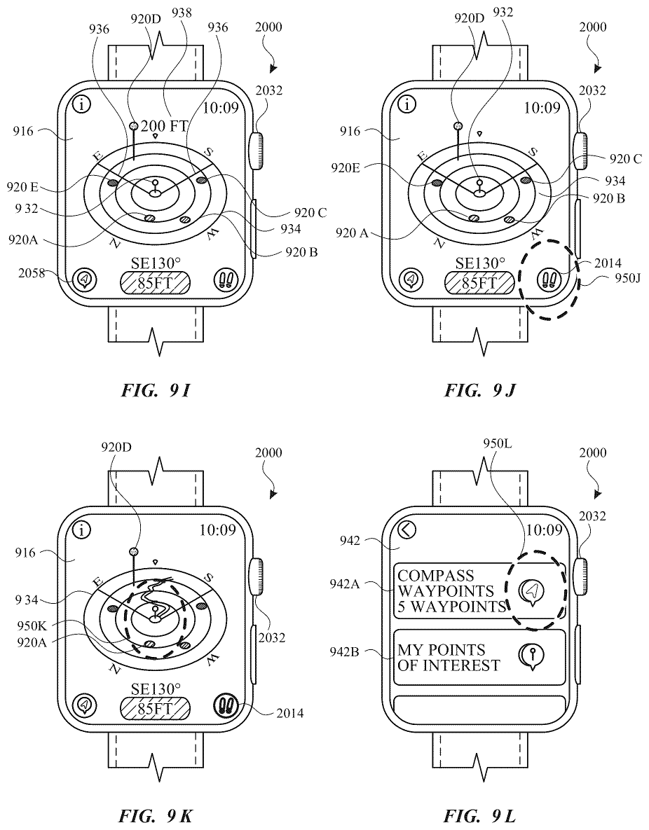

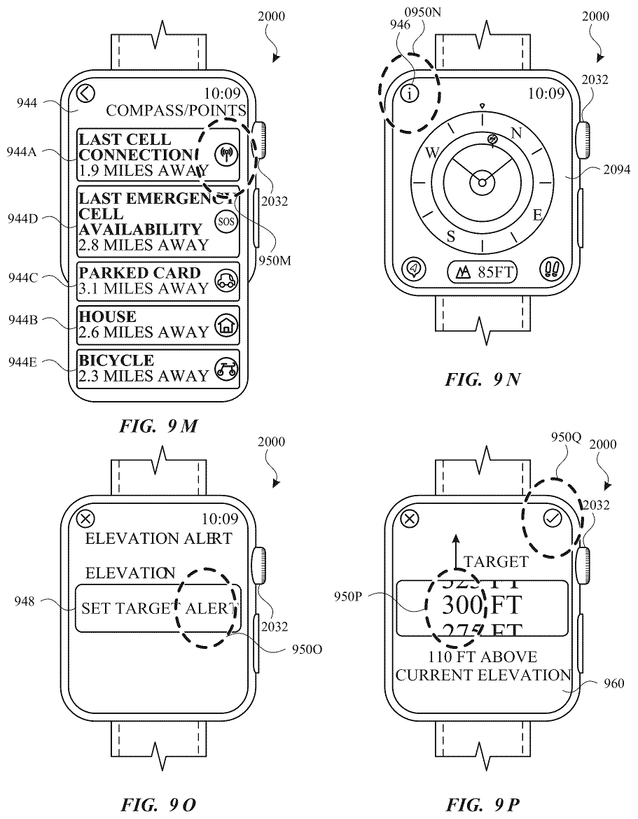

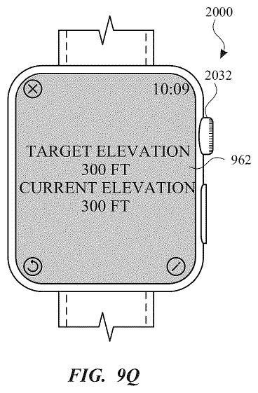

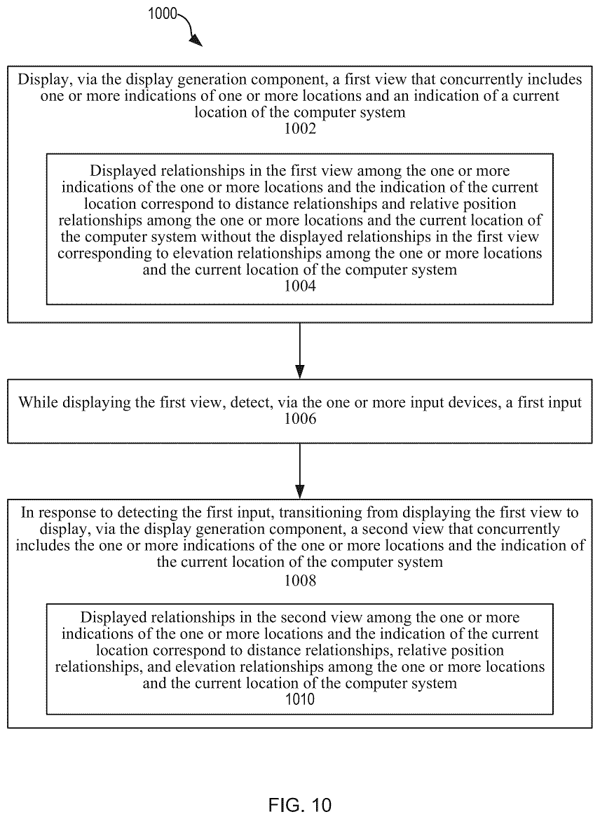

FIGS. 9A-9Q illustrate exemplary user interfaces for transitioning among different views of indications of locations, in accordance with some embodiments. The user interfaces in these figures are used to illustrate the processes described below, including the processes in FIG. 10.

At FIG. 9A, device 2000 displays, on display 2001, home screen user interface 902 that includes a plurality of icons, each of which, when activated (e.g., via a tap input) cause device 2000 to display a user interface for a respective corresponding application. At FIG. 9A, device 2000 detects tap input 950A (e.g., via a touch-sensitive surface that is part of display 2001) on compass icon 902A, which corresponds to a compass application. In response to detecting tap input 950A on compass icon 902A, device 2000 displays a high-visibility view 910 of the compass application, as shown in FIG. 9B.

At FIG. 9B, high-visibility view 910 includes arrow 910A, textual direction indicator 910B, and numeric direction indicator 910C. Arrow 910A operates like a compass needle and points to north, updating on the display as device 2000 rotates so that arrow 910A continues pointing north. Textual direction indicator 910B indicates a cardinal or ordinal direction (e.g., N, S, W, E, NE, SE, SW, and/or NW) to which device 2000 is point (e.g., as the device is worn on a hand of a user). Numeric direction indicator 910C indicates numeric degree to which device 2000 is pointing. High-visibility view 910 does not include an indication of the current location of device 2000 or indications for other locations. At FIG. 9B, device 2000 detects rotation 950B (e.g., a clockwise rotation) of rotational element 2032 (e.g., a rotatable input mechanism and/or a crown). In response to detecting rotational 950B, device 2000 transitions from displaying high-visibility view 910 to displaying hybrid view 912, as shown in FIG. 9C.

At FIG. 9C, hybrid view 912 includes arrow 912A, textual direction indicator 910B, numeric direction indicator 910C, location indicators 920A-920E, current elevation option 930, and backtrack affordance 2014. Hybrid view 912 includes many of the same features as described above with respect to navigational user interface 2002. Arrow 912A operates like a compass needle and points to north, updating on the display as device 2000 rotates so that arrow 912A continues pointing north. Textual direction indicator 912B indicates a cardinal or ordinal direction (e.g., N, S, W, E, NE, SE, SW, and/or NW) to which device 2000 is point (e.g., as the device is worn on a hand of a user). Numeric direction indicator 912C indicates numeric degree to which device 2000 is pointing. Location indicators 920A-920E each correspond to a different location (e.g., a historical location at which the user has placed a waypoint marker and/or a location of significance (e.g., last known cell service and/or where the user's car is parked)). In hybrid view 912, location indicators 920A-920E are distributed around a circle, with each of their locations representing the direction in which a corresponding respective physical location (e.g., a campground, last known cell service location, and/or the user's vehicle) is located. Thus, while hybrid view 912 provides the user with information about the direction of the various locations with respect to the current location of device 2000, hybrid view 912 does not provide information about the distances to the various locations and does not provide information about (absolute or relative) elevations of the various locations. Current elevation option 930 indicates the current elevation of device 2000 in relation to sea level (e.g., 85 feet above sea level). Backtrack affordance 2014, when activated, causes device 2000 to display information about a path that device 2000 traversed to arrive at the current location (e.g., as described in greater detail with respect to historic location indicator 2028, above). New waypoint affordance 2058, when activated, initiates a process to add a new waypoint. In some embodiments, device 2000 detects tap input 950C on current elevation option 930 and, in response, device 2000 displays elevation view 916. In some embodiments, device 2000 detects rotation 950D (e.g., a clockwise rotation) of rotational element 2032 (e.g., a rotatable input mechanism and/or a crown). In response to detecting rotational 950D, device 2000 transitions from displaying hybrid view 912 to displaying distance view 914, as shown in FIG. 9D.

In some embodiments, device 2000 detects a user input (e.g., a two-finger tap-and-hold on display 2001) (e.g., while displaying high-visibility view 910, hybrid view 912, distance view 914, elevation view 916, and/or targeted navigational interface 2094) and, in response, device 2000 outputs audio (e.g., spoken audio) that includes a current location of device 2000, a current direction of device 2000, and/or a heading.

At FIG. 9D, distance view 914 includes arrow 912A, location indicators 920A-920E, current elevation option 930, and backtrack affordance 2014. Distance view 914 includes many of the same features as described above with respect to navigational user interface 902. In distance view 914, the positions of location indicators 920A-920E indicate the directions and distances (e.g., from the current location of device 2000) of the locations corresponding to location indicators 920A-920E. In some embodiments, in distance view 914, the positions of location indicators 920A-920E indicate the directions and distances among the locations corresponding to location indicators 920A-920E and the directions and distances to the locations from the current location. Current location indicator 932 represents the current location of device 2000. Thus, distance view 914 provides the user with information about the distance and direction of the various locations represented by location indicators 920A-920E and the current location of device 2000. In distance view 914, the positions of location indicators 920A-920E do not indicate the elevations (e.g., with respect to sea level and/or in relation to the current elevation of device 2000) of the locations corresponding to location indicators 920A-920E. In some embodiments, at FIG. 9D, device 2000 detects rotation 950E of rotational element 2032 (e.g., a rotatable input mechanism and/or a crown). In response to detecting rotation 950E and in accordance with a determination that the rotation is a counterclockwise rotation, device 2000 transitions from displaying distance view 914 to displaying hybrid view 912, as shown in FIG. 9C. In response to detecting rotation 950E and in accordance with a determination that the rotation is a clockwise rotation, device 2000 changes a scale (e.g., zooms out) of distance view 914. In some embodiments, at FIG. 9D, device 2000 detects tap input 950F on current elevation option 930 and, in response, device 2000 transitions from displaying distance view 914 to displaying elevation view 916, as shown in FIG. 9G.

As shown in FIG. 9G, in some embodiments, elevation view 916 is a simulated three-dimensional view and/or a perspective view that includes location indicators 920A-920E. In elevation view 916, the positions of location indicators 920A-920E and current location indication 932 indicate the elevations (e.g., with respect to the lowest elevation among the locations and device 2000, with respect to sea level, and/or in relation to the current elevation of device 2000) of the locations corresponding to location indicators 920A-920E and the current location of device 2000. In addition, in elevation view 916, the positions of location indicators 920A-920E indicate the directions and distances among the locations corresponding to location indicators 920A-920E and the directions and distances to the locations from the current location. Thus, elevation view 916 provides the user with information about the distance, direction, and elevation of the various locations represented by location indicators 920A-920E and the current location of device 2000.

In some embodiments, in transitioning from distance view 914 to elevation view 916, device 2000 displays an animation that tilts circle 934 into a perspective view to represent a base plane, as shown in FIGS. 9D-9G. In some embodiments, in transitioning from distance view 914 to elevation view 916, device 2000 displays an animation that raises respective indicators of locations (e.g., 920A and 920B) that are within an area defined by (between) 936 and optionally raises current location indicator 932, as shown in FIGS. 9D-9G. In some embodiments, the respective indicators of locations and current location indicator 932 are raised a respective amount that is based on an elevation of the respective locations corresponding to the indicators. For example, at FIG. 9E, location indicator 920A and location indicator 920B have raised the same amount, and at FIGS. 9F-9G, location indicator 920A has ceased rising and location indicator 920B has raised up further, indicating that location indicator 920B corresponds to a location that is at a higher elevation than the location that corresponds to location indicator 920A. In some embodiments, the various location indicators rise at the same level, but for different durations (and thus rise different distances) based on the respective elevations of the locations corresponding to the various location indicators. In some embodiments, 934 represents a base plane with an elevation that is based on (equal to) the lowest elevation from among the current location and the locations represented by location indicators that are contained within the area defined by (between) 936. In some embodiments, the elevation (e.g., relative to sea level and/or another elevation) of respective indications (e.g., 920A, 920B, and/or 932 in FIG. 9G) are represented by respective lines (e.g., vertical lines) that extend from base plane 934 and the length of the lines are in proportion to the elevations (e.g., relative elevations) of the locations corresponding to the respective indications.

At FIG. 9G, in elevation view 916, device 2000 displays direction and distance information about the locations corresponding to location indicators 920C-920E, without raising location indicators 920C-920E to show corresponding elevation information (e.g., because location indicators 920C-920E are not within the area defined by 936). In some embodiments, at FIG. 9G, device 2000 detects tap input 950G on current elevation option 930 and, in response, device 2000 transitions from displaying elevation view 916 to displaying distance view 914 (e.g., reverses the animation of FIGS. 9D-9G), as shown in FIG. 9D. In some embodiments, device 2000 detects rotation 950H and, in response, changes a scale (e.g., zooms in or out, based on direction of rotation) of elevation view 916. In some embodiments, changing a scale of elevation view 916 causes additional location indicators to be displayed (e.g., within area defined by (between) 936) and/or causes some location indicators to no longer be displayed.

At FIG. 9G, device 2000 detects rotation 950I of device 2000, causing device 2000 to go from pointing to northwest to pointing to southeast. In response to detecting rotation 950I of device 2000, device 2000 updates the positions of location indicators 920A-920E in elevation view 916, which moves location indicators 920A and 920B out of the area defined by 936 and brings location indicator 920D into the area defined by 936, as shown in FIG. 9I. As a result, device 2000 lowers location indicators 920A and 920B to base plane 934 and optionally raises location indication 920D above base plane 934 to represent the elevation of the location corresponding to location indication 920D, as shown in the animation at FIGS. 9G-91. Base plane 934 represents the lowest of elevations of the current location and the locations with indicators within the area defined by 936 (e.g., in FIG. 9H the elevation of base plane 934 correspond to the lower of the elevations of the current location of device 2000 and the elevation of the location corresponding to location indication 920D). Thus, in some embodiments, the elevation of base plane 934 changes when device 2000 rotates and/or when the scale of elevation view 916 changes.

At FIG. 9I because the elevation of location indicator 920D is newly displayed, device 2000 displays (for a predetermined amount of time) (on display 2001 adjacent to 920D) numeric indication 938 (e.g., “200 ft”) of the elevation (e.g., above sea level) of the location corresponding to location indicator 920D. At FIG. 9J, after the predetermined amount of time, device 2000 ceases to display numeric indication 938. At FIG. 9J, device 2000 detects tap input 950J on backtrack affordance 2014. In response to detecting tap input 950J on backtrack affordance 2014, device 2000 displays path 940 that shows the path that device 2000 traveled to arrive at the current location. As shown in FIG. 9K, location indicator 920D corresponds to a location at which cellular service was last available, and device 2000 automatically added location indicator 920D corresponding to the location at which cellular service was last available as a waypoint, thereby allowing the user to backtrack to that location to make a call (e.g., an emergency call).

At FIG. 9K, device 2000 detects tap input 950K on base plane 934 (and/or on a displayed location indicator (e.g., 920A)) and, in response, displays waypoints menu 942, as shown in FIG. 9L. At FIG. 9L, waypoints menu 942 includes first option 942A that corresponds to waypoints (e.g., user selected and automatically added, such as last location of cellular service) and second option 942B that corresponds to nearby (e.g., within a threshold distance) points of interest. At FIG. 9L, device 2000 detects tap input 950L on first option 942A and, in response, device 2000 displays (e.g., scrollable) list 944 of locations (waypoints) that correspond to location indicators 920A-920E. At FIG. 9M, list 944 includes items 944A-944E. Device 2000 detects tap input 950M on item 944A and, in response, displays a targeted navigational interface 2094 for navigating to the location corresponding to item 944A, as shown in FIG. 9N.

At FIG. 9N, device 2000 detects one or more inputs (e.g., including tap input 950N on information object 946) and, in response, displays option 948 for setting an elevation alert, as shown in FIG. 9O. At FIG. 9O, device 2000 detects tap input 950O on option 948, which displays elevation setting user interface 960. At FIG. 9P, device 2000 receives inputs 950P and 950Q to set a target elevation of 300 feet. Subsequently, device 2000 monitors the current elevation of device 2000. At FIG. 9Q, device 2000 detects that device 2000 has reached (or crossed) the target elevation and, in response, outputs alert 962 indicating that the target elevation has been reached.

FIG. 10 is a flow diagram illustrating methods of transitioning among different views of indications of locations, in accordance with some embodiments. Method 1000 is performed at a computer system (e.g., 1100 and/or 2000) (e.g., a smartwatch, a smartphone, a tablet, a laptop computer, and/or a head mounted device (e.g., a head mounted augmented reality and/or extended reality device)) that is in communication with a display generation component (e.g., 2001) (e.g., a display controller, a touch-sensitive display system, a monitor, and/or a head mounted display system) and one or more input devices (e.g., 2001 and/or 2032) (e.g., a touch-sensitive surface, a keyboard, a rotatable input mechanism, and/or a mouse). Some operations in method 1000 are, optionally, combined, the orders of some operations are, optionally, changed, and some operations are, optionally, omitted.

As described below, method 1000 provides an intuitive way for transitioning among different views of indications of locations. The method reduces the cognitive burden on a user that views indications of locations, thereby creating a more efficient human-machine interface. For battery-operated computing devices, enabling a user to view indications of locations faster and more efficiently conserves power and increases the time between battery charges.

The computer system (e.g., 2000) displays (1002), via the display generation component (e.g., 2001), a first view (e.g., 914 at FIG. 9D) (e.g., a two-dimensional view) that concurrently includes one or more indications (e.g., 920A-920E at FIG. 9D) of one or more locations (e.g., indications of one or a plurality of historic locations that the computer system has been and/or indications of waypoints and/or a first indication for a first location and a second indication for a second location) and an indication (e.g., 932 at FIG. 9D) of a current location of the computer system.

The displayed relationships (1004) (e.g., distances between and/or relative positions of) in the first view (e.g., 914 at FIG. 9D) among the one or more indications (e.g., 920A-920E at FIG. 9D) of the one or more locations (e.g., a location of a parked car, a location of a trail head, and/or a location of a point of interest) and the indication (e.g., 932 at FIG. 9D) of the current location correspond to (e.g., are based on and/or are to scale with) distance relationships and relative position relationships (e.g., based on location data (e.g., geographic location data, either estimated (e.g., based on data from one sensor type (e.g., gyroscope or accelerometer sensors)) or actual (e.g., based a different sensor type (e.g., GPS sensor)))) among the one or more locations and the current location of the computer system (e.g., 2000) without the displayed relationships in the first view (e.g., 914 at FIG. 9D) corresponding to elevation relationships among the one or more locations and the current location of the computer system. In some embodiments, the first view is a two-dimensional view that includes indications of various locations. The indications are arranged to show the relative distances between the various locations and to show the relative positions of the various positions of the locations with respect to each other. In some embodiments, in the first view, the indications are not arranged in a manner to reflect/disclose elevations of the various locations (e.g., absolute elevations or elevations relative to each other).

While displaying the first view (e.g., 914 at FIG. 9D), the computer system (e.g., 2000) detects (1006), via the one or more input devices, a first input (e.g., 950F and/or 950E).

In response to detecting the first input (e.g., 950F and/or 950E), the computer system (e.g., 2000) transitions (1008) (e.g., FIGS. 9D-9G) from displaying the first view (e.g., 914 at FIG. 9D) to displaying, via the display generation component, a second view (e.g., 916 at FIG. 9G) that concurrently includes the one or more indications (e.g., 920A-920E at FIG. 9G) of the one or more locations (e.g., indications of one or a plurality of historic locations that the computer system has been and/or indications of waypoints) and the indication (e.g., 932 at FIG. 9G) of the current location of the computer system.

The displayed relationships (1010) (e.g., distances between, relative positions of, and elevations) in the second view (e.g., 916 at FIG. 9G) among the one or more indications (e.g., 920A-920E at FIG. 9G) of the one or more locations and the indication (e.g., 932 at FIG. 9G) of the current location correspond to (e.g., are based on and/or are to scale with) distance relationships, relative position relationships, and elevation relationships (e.g., based on location data (e.g., geographic location data, either estimated (e.g., based on data from one sensor type (e.g., gyroscope or accelerometer sensors)) or actual (e.g., based a different sensor type (e.g., GPS sensor)))) among the one or more locations and the current location of the computer system. Displaying the second view that includes elevation relationships provides the user with visual feedback about the relative elevations among the various locations, thereby providing improved visual feedback.

In some embodiments, transitioning from displaying the first view (e.g., 914 at FIG. 9D) to the second view (e.g., 916 at FIG. 9G) includes animating raising at least one of the one or more indications (e.g., 920A and 920B in FIGS. 9E-9G) of the one or more locations and the indication (e.g., 932 at FIGS. 9E-9G) of the current location of the computer system (e.g., raise a location indication 920A and/or the indication of the current location) in relation to a (e.g., displayed or not displayed) base plane (e.g., 934) (e.g., the one or more indication of the one or more locations and/or the indication of the current location are located on the base plane while in the first view). In some embodiments, the first view is a two-dimensional view and the second view is a three-dimensional view (e.g., a perspective view). In some embodiments, in the first view the indications of the various locations (one or more locations and current location) are displayed on a single plane and in the second view the indications of the various locations are displayed in different planes (e.g., the planes are based on the altitude of the respective locations). In some embodiments, the animation from the first view to the second view includes indications of various locations rising above the base plane to their respective planes (based on their altitude). Animating the indications rising to show respective elevations provides the user with visual feedback that the placement of the indications represent elevations, thereby providing improved visual feedback.

In some embodiments, the base plane (e.g., 934) represents an elevation that is the lowest elevation of the one or more locations and the current location. In some embodiments, when the current location has a lower elevation as compared to the one or more locations, the base plane represents the elevation of the current location and the indication of the current location is represented on the base plane. In some embodiments, when a first location of the one or more locations has an elevation that is lower than the current location (and the other one or more locations), the base plane represents the elevation of the first location and the indication of the first location is represented on the base plane (and the location of the current location is represented to appear to be above the base plane). The base plane representing the lowest elevation from among the various locations enables indications of all other locations to be displayed above the base plane and thus not obscured by the base plane, thereby providing improved visual feedback.

In some embodiments, the animation (e.g., at FIGS. 9D-9G) of raising a respective indication (e.g., 920A and/or 920B) (e.g., an indication of the one or more indications and/or the indication of the current location) includes raising the respective indication an amount that is based on a difference of the elevation of a location corresponding to the respective indication and the elevation represented by the base plane (e.g., 934). Raising the respective indications above the base plane provides the user with visual feedback about how much higher in elevation the respective corresponding locations are, thereby providing improved feedback.

In some embodiments, the second view (e.g., 916 at FIG. 9G) includes, concurrently with the one or more indications (e.g., 920A-920B) of the one or more locations and the indication of the current location of the computer system, a plurality of other indications (e.g., 920C-920E) of a plurality of other locations. In some embodiments, the displayed relationships (e.g., distances between, relative positions of, and elevations) in the second view among the plurality of other indications (e.g., 920C-920E) of the plurality of other locations correspond to (e.g., are based on and/or are to scale with) distance relationships and relative position relationships without the displayed relationships in the second view corresponding to elevation relationships among the plurality of other indications. In some embodiments, the second view includes indications of a plurality of other locations that show the distance and relative positions of the other locations, but that does not show the relative elevations of the plurality of locations. Showing distance and direction relationship information for some points without showing the elevation relationship for those points helps to not clutter the user interface, thereby enabling the user to better recognize the elevation differences of the points that are of interest, thus providing improved visual feedback.

In some embodiments, computer system (e.g., 2000) detects (e.g., via a magnetometer) a rotation (e.g., 9501) of the computer system (e.g., detecting that the computer system has rotated with respect to North). In response to detecting the rotation of the computer system: the computer system (e.g., 2000) raises (by animating an update of the second view) a first respective indication (e.g., 920D at FIGS. 9H-91) of the plurality of other indications in relation to a base plane (e.g., 934) based on an altitude of a first respective location corresponding to the first respective indication; and the computer system (e.g., 2000) lowers (by animating an update of the second view) a second respective indication (e.g., 920A at FIG. 9H) of the one or more indications to the base plane (e.g., 934) independent of the altitude of a second respective location corresponding to the second respective indication. In some embodiments, a direction indicator is displayed that overlaps a portion of the base plane, and indications that are within the direction indicator are raised to show their altitude while indications that are not within the direction indicator are displayed on the base plane (not showing their altitude). In some embodiments, the raising of indications coming into the direction indicator and the lowering of indications leaving the direction indictor happens concurrently. Rotating the device to show the elevation for some indications allows the user to specify for which points the elevations should be displayed, thereby providing the user with more control and improved feedback.

In some embodiments, in response to detecting the rotation (e.g., 9501) of the computer system (e.g., 2000), the computer system displays, via the display generation component (e.g., adjacent to the second respective indication) for an amount (e.g., a predefined amount) of time (e.g., before ceasing to display without requiring additional user input), a textual representation (e.g., 938 at FIG. 9I) of an altitude (e.g., an absolute amount, 300 feet, 350 feet, or 654 feet above sea level) of the first respective location. In some embodiments, the computer system temporarily shows textual elevations next to points that come within the direction indicator (e.g., that raise up). Temporarily showing textual elevation information next to indications provides the user with precise feedback about the elevation (e.g., above sea level) for the corresponding location, thereby providing improved visual feedback.

In some embodiments, the computer system (e.g., 2000) displays, via the display generation component (e.g., 2001) and concurrently with the first view (e.g., 912 at FIG. 9C), a textual representation (e.g., 930) of a current elevation (e.g., 65 feet, 102 feet, or 322 feet above sea level) of the computer system. In some embodiments, the elevations of the one or more locations is not displayed in the first view. Displaying text of the current elevation of the computer system provides the user with precise feedback about the device's current elevation, thereby providing improved feedback.

In some embodiments, detecting, via the one or more input devices, the first input includes detecting a touch input (e.g., 950C) (e.g., a tap or a tap-and-hold) at a location corresponding to the textual representation (e.g., 930) of the current elevation of the computer system. Displaying the second view that includes elevation relationships provides the user with visual feedback about the relative elevations among the various locations, thereby providing improved visual feedback.

In some embodiments, while displaying the second view (e.g., 916 at FIG. 9G), the computer system (e.g., 2000) detects, via the one or more input devices, a second input (e.g., 950G) (e.g., a tap input on a textual representation of the current elevation of the computer system). In response to detecting the second input (e.g., 950G), the computer system (e.g., 2000) transitions (e.g., including an animation) from the second view (e.g., 916 at FIG. 9G) to the first view (e.g., 914 at FIG. 9D). Displaying the first view that does not include elevation relationships provides the user with a simplified view about the distances and positions of the various locations, thereby providing improved visual feedback.

In some embodiments, prior to displaying the first view (e.g., 914 at FIG. 9D), the computer system (e.g., 2000) displays, via the display generation component, a third view (e.g., 912 at FIG. 9C) (e.g., a two-dimensional view) that concurrently includes the one or more indications of the one or more locations (e.g., indications of one or a plurality of historic locations that the computer system has been and/or indications of waypoints and/or a first indication for a first location and a second indication for a second location) and the indication of the current location of the computer system. The displayed relationships (e.g., distances between and/or relative positions of) in the third view among the one or more indications (e.g., 920A-920E) of the one or more locations and the indication of the current location correspond to (e.g., are based on and/or are to scale with) relative position relationships (e.g., based on location data (e.g., geographic location data, either estimated (e.g., based on data from one sensor type (e.g., gyroscope or accelerometer sensors)) or actual (e.g., based a different sensor type (e.g., GPS sensor)))) among the one or more locations and the current location of the computer system without the displayed relationships in the first view corresponding to distance relationships and elevation relationships among the one or more locations and the current location of the computer system. In some embodiments, the third view is a two-dimensional view that includes indications of various locations. The indications are arranged to show the relative positions of the various positions of the locations with respect to each other. In some embodiments, in the third view, the indications are not arranged in a manner to reflect/disclose distances and/or elevations (e.g., absolute elevations or elevations relative to each other) among the various locations. In some embodiments, the computer system receives a user input (e.g., a tap input on a textual representation of the current elevation of the computer system) and, in response transitions from the third view to the first view. Displaying the first view that does not include elevation relationships and distance relationships provides the user with a simplified view about the positions of the various locations, thereby providing improved visual feedback.

In some embodiments, prior to displaying the third view (e.g., 912), the computer system (e.g., 2000) displays, via the display generation component, a fourth view (e.g., 910) (e.g., a two-dimensional view) that includes a current bearing (e.g., 910A) of the computer system (e.g., 2000) and that does not include the one or more indications of the one or more locations (e.g., indications of one or a plurality of historic locations that the computer system has been and/or indications of waypoints and/or a first indication for a first location and a second indication for a second location). In some embodiments, the fourth view does not include direction/distance/elevation relationships among the various points/locations. In some embodiments, the computer system receives a user input (e.g., a tap input on a textual representation of the current elevation of the computer system and/or rotation of a rotatable input mechanism) and, in response transitions from the fourth view to the third view. Showing the current bearing without showing any relationships to the various locations provides the user with a simplified view about the bearing of the computer system, thereby providing improved visual feedback.

In some embodiments, while displaying the second view (e.g., 916 at FIG. 9K), the computer system (e.g., 2000) detects, via the one or more input devices, a set of one or more inputs that includes an input (e.g., 950K, 950L, and/or 950M) directed to (e.g., a tap input on) a respective indication that corresponds to a respective location. In response to detecting the input directed to the respective indication, the computer system (e.g., 2000) displays, via the display generation component, a textual distance (e.g., 100 meters, 0.3 miles, and/or 1.21 miles) from the current location to the respective location (e.g., in 944A at FIG. 9M) and a textual elevation (e.g., in 944A at FIG. 9M) (e.g., up 300 feet, up 33 feet, or down 120 feet) difference between the current location and the respective location. In some embodiments, the computer system detects a tap input on the respective indication and, in response, displays a list that corresponds to the one or more indications. In response to detecting a tap input on a respective item in the list that corresponds to the respective location, the computer system displays the textual distance and textual elevation. Enabling the user to select a specific location to see additional details about the location provides the user with additional feedback about that location, thereby providing improved feedback.

In some embodiments, the computer system (e.g., 2000) receives user input (e.g., 9500, 950P, and/or 950Q) selecting a target elevation (e.g., as in FIG. 9P). The computer system (e.g., 2000) detects that the computer system has reached the target elevation (e.g., the user wearing the computer system has hiked down or hiked up to the target elevation). In response to detecting that the computer system (e.g., 2000) has reached the target elevation, the computer system (e.g., 2000) outputs (e.g., audio, visual, and/or tactile) an alert (e.g., 960 at FIG. 9P) (e.g., that indicates that the target elevation has been reached). Getting an alert that the computer system has reached the target elevation provides the user with feedback about the elevation of the computer system, thereby providing improved feedback.

In some embodiments, while displaying the second view (e.g., 916 at FIG. 9K), the computer system (e.g., 2000) detects, via a rotatable input device of the one or more input devices, a rotational input. In response to detecting the rotational input, the computer system changes a scale of distances among the one or more indications of the one or more locations and the indication of the current location (and, optionally showing an indication of scale (e.g., on the base plane)). Changing a scale of the second view provides the user with additional feedback about additional locations and/or provides the user with more granular feedback about fewer locations, thereby providing improved visual feedback.

In some embodiments, the computer system (e.g., 2000) detects that the computer system is no longer in communication range of a cellular service provider of the computer system. In response to detecting that the computer system is no longer in communication range of the cellular service provider of the computer system, the computer system adds an indication (e.g., 920D), as part of the first view and/or the second view, corresponding to a last location that the computer system was in communication range of the cellular service provider. In some embodiments, when the computer system goes out of cellular connection range of the service provider, the first view and/or second view automatically show a point corresponding to a location of the last place a cellular connection was available (of the service provider, even though other service provides are available and in communication range of the computer system). Automatically show an indication corresponding to last cellular connection (e.g., of the device's cellular service provider) when out of cellular connection range provides the user with feedback about where to go back to get cellular service (e.g., in case of an emergency).

In some embodiments, the computer system (e.g., 2000) detects that the computer system is no longer in communication range of any cellular service provider. In response to detecting that the computer system is no longer in communication range of any cellular service providers, the computer system (e.g., 2000) adds an indication (e.g., 920D), as part of the first view and/or the second view, corresponding to a last location that the computer system was in communication range of any cellular service provider. In some embodiments, when the computer system goes out of cellular connection range of all cellular service providers, the first view and/or second view automatically show a point corresponding to the location of the last place where a cellular connection (of any service provider) was available. Automatically show an indication corresponding to last emergency cellular communication connection (e.g., of any cellular service provider that works with the computer system) when out of cellular connection range provides the user with feedback about where to go back to get cellular service (e.g., in case of an emergency).

### VI. Altitude Alert

In some embodiments, a mobile device (e.g., a phone or a wearable device such as a watch) can alert users when the device reaches a set altitude (or elevation) threshold. This can be used in the following use cases: pacing ascents to avoid altitude sickness, celebratory moments reaching certain altitudes, fire or camp limitations above certain altitudes, and backcountry skiing limitations below certain altitudes.

A mobile device (e.g., a phone or a wearable device such as a watch) can alert users when the device reaches a target altitude, either above or below the target. However, frequent and unwanted notifications may occur when the device moves up and down while close to the target altitude or when a user incidentally raises or lowers the arm with the device.

### A. Architecture

The disclosed techniques add a programmable threshold amount of altitude around the monitored (or measured) altitude to reduce or prevent unwanted notifications by enabling and disabling notifications at appropriate times when the mobile device travels up and down while close to a target altitude. The threshold amount around the monitored (or measured) altitude may be viewed as a band along the trajectory line of the monitored altitude.

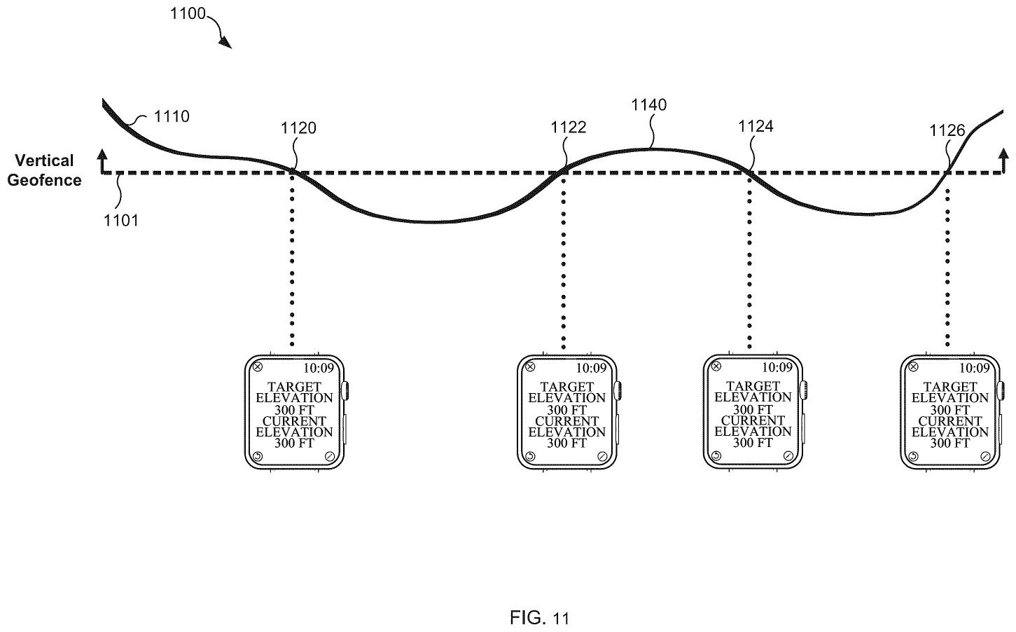

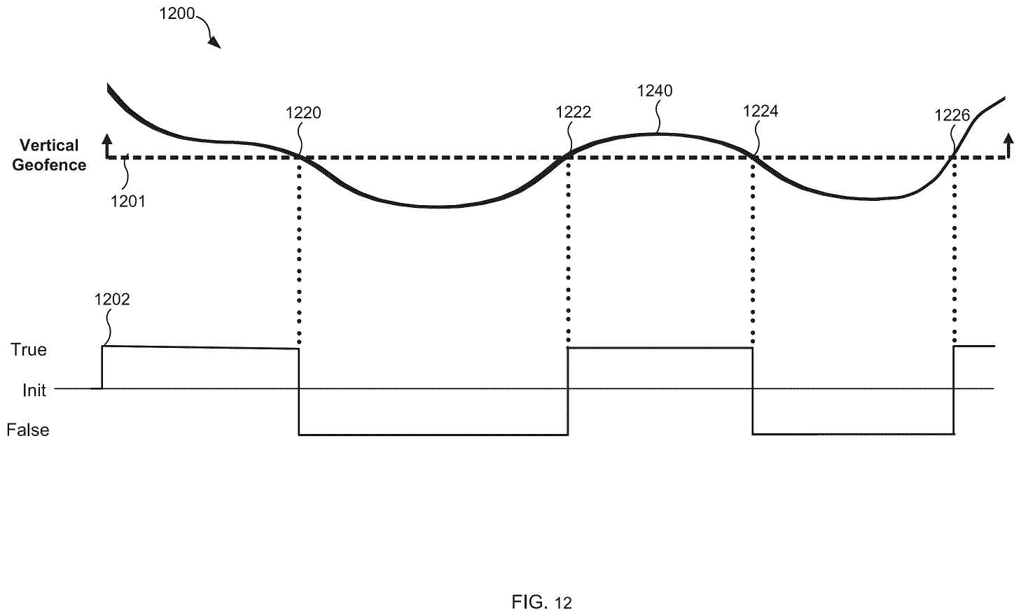

FIGS. 11 and 12 below illustrate altitude alerts triggered by the vertical geofence whenever a target altitude is reached or crossed. Excessive and unwanted alerts are shown. FIG. 12 shows additional vertical geofence signal changes.

FIG. 11 illustrates a vertical geofence at a target altitude and alerts when the target altitude is reached, according to some embodiments. Line 1110 shows the altitude change over time. When the altitude of the device reaches the target altitude 1101, an alert can be provided on the screen of the device. Typically, when a user of a mobile device moves up (or ascends in elevation) and down a hill (or descends in elevation), its movement may be categorized as crossing a target altitude or attaining a target altitude. Crossing a target altitude may include crossing-on-the-way-up 1126, and crossing-on-the-way-down 1120. Attaining a target altitude may include reaching a hilltop 1140 or reaching a valley (not shown but similar to 1140 in the opposite direction). When crossing a target altitude, the user usually would like an alert when the device reaches the target altitude. However, when attaining a target altitude, since the trajectory line may be above or below but close to the target altitude, excessive and unwanted alerts (e.g., 1122 and 1124) may occur.

FIG. 12 illustrates the vertical geofence notifications when a user travels above and below a target altitude, according to some embodiments. A vertical geofence signal 1202 may change with the monitored current altitude and control notifications (described below). For the vertical geofence signal 1202 changes from true (or true/high state) to false (or false/low state when a mobile device drops below the target altitude (e.g., 1220 and 1224), and changes from false to true when the mobile device goes above the target altitude (e.g., 1222 and 1226).

### B. Unwanted Notification Prevention

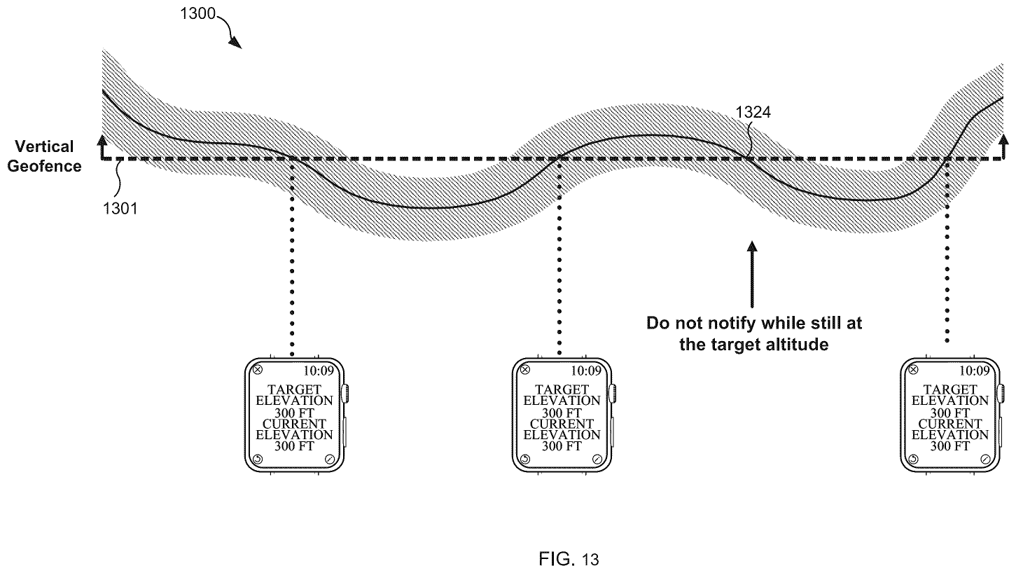

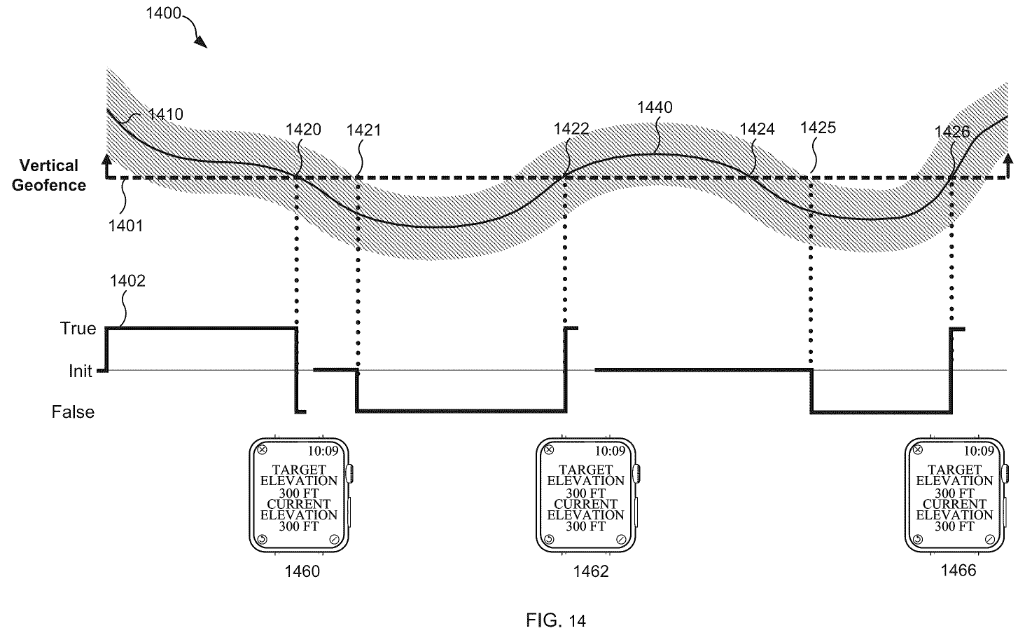

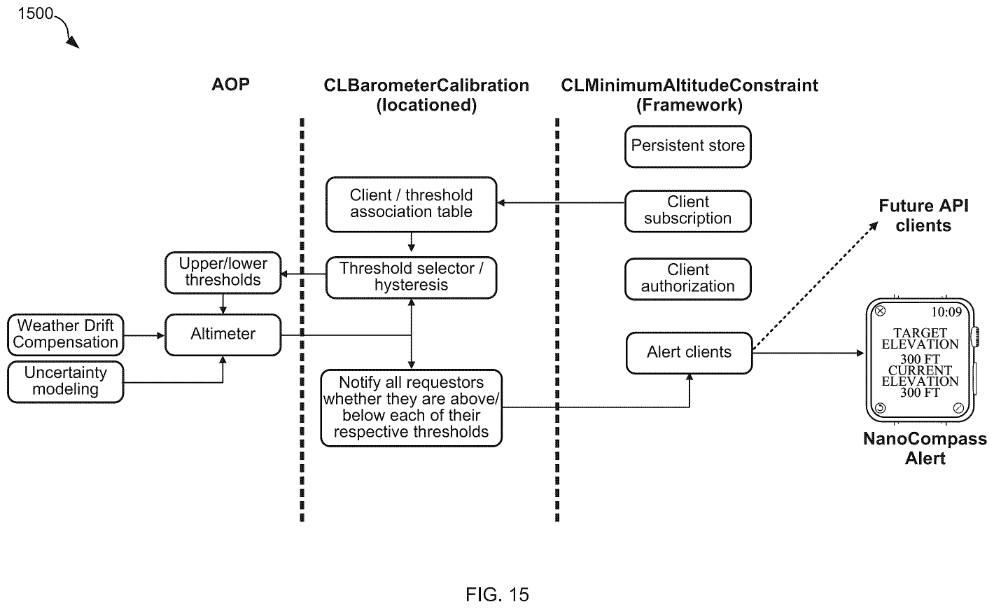

The following figures, FIGS. 13 and 14, illustrate the disclosed techniques for preventing unwanted or excessive notifications, such as during target altitude attainments (e.g., hilltop or valley). A framework utilizing the disclosed techniques is also shown in FIG. 15.

FIG. 13 illustrates a mechanism to prevent unwanted notifications, according to some embodiments. FIG. 13 shows a shaded band around the trajectory line. This band indicates that after an alert is triggered, a new alert will not be provided until the mobile device has an altitude that is different from the target altitude by at least a threshold amount. In some embodiments, the threshold amount (i.e., the band) may be a programmable height (e.g., a few feet) set by a user of the mobile device or the manufacturer of the mobile device, As seen at time 1324, a new alert (notification) will not be provided as the band does not leave the vertical geofence. That is, the altitude does not go significantly (sufficiently) above the target altitude for the notification mechanism to reset.

FIG. 14 illustrates a mechanism to prevent unwanted notifications using a vertical geofence signal, according to some embodiments. As discussed above, the vertical geofence signal 1402 may change with the monitored current altitude and control notifications (e.g., neutral state disables notifications, and true or false state enables notifications). The vertical geofence signal 1402 (e.g., acting as a control signal) may be reset (i.e., by disabling notifications) after each notification and does not start (i.e., enabling notifications) again until the current altitude differs from the target altitude by a threshold. For example, the signal 1402 changes from true (or true/high state) to false (or false/low state) when a mobile device drops below the target altitude (i.e., crossing on the way down) at time 1420 and triggers a notification 1460. The signal 1402 is then reset (i.e., notification is disabled and goes to the “init” (or neutral) state) soon after. When the mobile device moves below the target altitude by more than the threshold amount (e.g., the band), the notification is enabled again, for example, at time 1421 by returning the signal 1402 to the false/low state.

At time 1422, the signal 1402 changes from false to true when the mobile device goes above the target altitude and triggers a notification 1462. The signal 1402 is then reset (i.e., notification is disabled) again. However, the trajectory around the hilltop 1440 is still within the threshold amount (e.g., the band). Therefore, excessive and unwanted alerts (e.g., 1424) can be avoided. The notification is not enabled again until time 1425 when the mobile device moves below the target altitude by more than the threshold amount. At time 1426, the mobile device goes above the target altitude (i.e., crossing on the way up), and the signal 1402 changes from false to true accordingly, followed by a notification 1466.

In summary, the signal 1402 may be reset (i.e., notification is disabled and goes to the “init” (or neutral) state) each time after a notification is triggered (e.g., 1420, 1422, and 1426). The notification can be enabled again when the mobile goes above or below the target altitude by more than the threshold amount (i.e., outside the band), by changing the signal 1402 from the “init” state to the “true” state (not shown) if above the target altitude, or “false” state (e.g., 1421 and 1425) if below the target altitude, respectively.

FIG. 15 shows the operation of a framework to track altitude and provide notifications, according to some embodiments. An always-on processor (AOP) can use an altimeter for making measurements and comparing a current altitude to a target altitude/elevation, including any upper and lower thresholds (e.g., as shown in FIG. 14). An altimeter can correct itself due to weather and provide compensation according to the weather drift.

### C. Flowchart

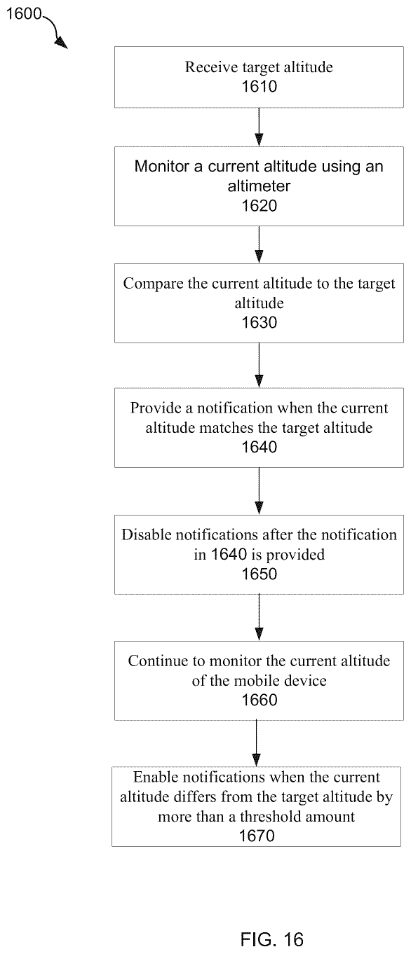

FIG. 16 is a flowchart illustrating a method of triggering an alert at a target altitude, according to some embodiments. In some implementations, one or more method blocks of FIG. 16 may be performed by a mobile device (e.g., architecture 1500, electronic device 1700). In some implementations, one or more method blocks of FIG. 16 may be performed by another device or a group of devices separate from or including the mobile device. Additionally, or alternatively, one or more method blocks of FIG. 16 may be performed by one or more components of the mobile device, such as computer-readable medium 1702, Input/Output (I/O) subsystem 1706, wireless circuitry 1708, sensors 1716, application processor 1718, etc.

At block 1610, a target altitude is received and stored. The target altitude can be received from a user. For example, if the target altitude is to be stored in a wearable mobile device, such as a watch, the user may enter the information into the watch via a user interface, such as voice command, a slider, typing, etc. Alternatively, the target altitude may also be entered into a mobile phone that is paired with the watch, for example, via Bluetooth. The mobile phone can then send the entered information to the watch.

At block 1620, the current altitude of the device is monitored using an altimeter. An altimeter in the mobile device can measure the current altitude of the device. For example, in FIG. 14, an altimeter in the mobile device measures the device's current altitude at different points in time.

At block 1630, the current altitude (also referred to as measured altitude) is compared to the target altitude. For example, the two values can be determined to be equal or different but within a threshold or tolerance. For example, as illustrated in FIG. 14, the current measured altitude of a mobile device is determined to be equal to the target altitude 1401 at time 1422. However, at 1440 (the hilltop), the measured altitude and the target altitude 1401 are different but within a threshold (e.g., the shaded band).

At block 1640, a notification is provided when the current altitude matches the target altitude. For example, in FIG. 14, a notification is triggered or provided (i.e., signal 1402 changes from “false” to “true” state) when the current altitude of the mobile device matches the target altitude 1410 at time 1422.

At block 1650, notifications are disabled after the notification in 1640 is provided. For example, in FIG. 14, the notification signal 1402 is reset to the “init” state after the notification is triggered at time 1422.

At block 1660, continue to monitor the current altitude of the mobile device. For example, in FIG. 14, during the signal's init state, the altimeter continues to monitor the device's current altitude at times 1440 and 1424.

At block 1670, notifications are enabled when the current altitude differs from the target altitude by more than a threshold amount. For example, in FIG. 14, when the current (or measured) altitude differs from the target altitude 1401 by a threshold (e.g., the shaded band) at time 1425, the notification feature is enabled by changing the notification signal 1402 from “init” state to “false” state.

### VII. Example Device

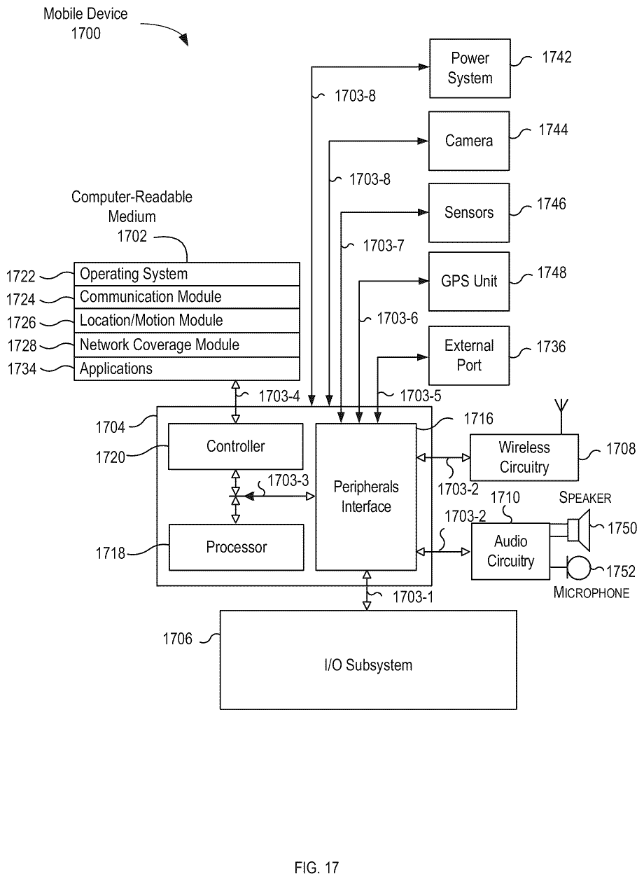

FIG. 17 is a block diagram of an example device 1700, which may be a mobile device. Device 1700 generally includes computer-readable medium 1702, a processing system 1704, an Input/Output (I/O) subsystem 1706, wireless circuitry 1708, and audio circuitry 1710 including speaker 1750 and microphone 1752. These components may be coupled by one or more communication buses or signal lines 1703. Device 1700 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 17 is only one example of an architecture for device 1700, and that device 1700 can have more or fewer components than shown, or a different configuration of components. The various components shown in FIG. 17 can be implemented in hardware, software, or a combination of both hardware and software, including one or more signal processing and/or application specific integrated circuits.

Wireless circuitry 1708 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1708 can use various protocols, e.g., as described herein.

Wireless circuitry 1708 is coupled to processing system 1704 via peripherals interface 1716. Interface 1716 can include conventional components for establishing and maintaining communication between peripherals and processing system 1704. Voice and data information received by wireless circuitry 1708 (e.g., in speech recognition or voice command applications) is sent to one or more processors 1718 via peripherals interface 1716. One or more processors 1718 are configurable to process various data formats for one or more application programs 1734 stored on medium 1702.

Peripherals interface 1716 couple the input and output peripherals of the device to processor 1718 and computer-readable medium 1702. One or more processors 1718 communicate with computer-readable medium 1702 via a controller 1720. Computer-readable medium 1702 can be any device or medium that can store code and/or data for use by one or more processors 1718. Medium 1702 can include a memory hierarchy, including cache, main memory, and secondary memory.

Device 1700 also includes a power system 1742 for powering the various hardware components. Power system 1742 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 1700 includes a camera 1744. In some embodiments, device 1700 includes sensors 1746. Sensors 1746 can include accelerometers, compasses, gyrometers, pressure sensors, audio sensors, light sensors, barometers, altimeter, and the like. Sensors 1746 can be used to sense location aspects, such as auditory or light signatures of a location.

In some embodiments, device 1700 can include a GPS receiver, sometimes referred to as a GPS unit 1748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 1700 may be configured to identify GLONASS signals, or any other similar type of satellite navigational signal.

One or more processors 1718 run various software components stored in medium 1702 to perform various functions for device 1700. In some embodiments, the software components include an operating system 1722, a communication module (or set of instructions) 1724, a location module (or set of instructions) 1726, a network coverage module 1728, a predicted app manager module 1730, and other applications (or set of instructions) 1734, such as a car locator app and a navigation app.

Operating system 1722 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1724 facilitates communication with other devices over one or more external ports1736 or via wireless circuitry 1708 and includes various software components for handling data received from wireless circuitry 1708 and/or external port1736. External port 1736 (e.g., USB, Fire Wire, Lightning connector, 60-pin connector, etc.) is adapted for coupling directly to other devices or indirectly over a network (e.g., the Internet, wireless LAN, etc.).

Location/motion module 1726 can assist in determining the current position (e.g., coordinates or other geographic location identifier) and motion of device 1700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module1726 receives data from GPS unit1748 and analyzes the signals to determine the current position of the mobile device. In some embodiments, location/motion module 1726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1708 and is passed to location/motion module 1726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1700 based on the position coordinates of the corresponding transmitters. Regardless of the specific location technology used, location/motion module 1726 receives information from which a location fix can be derived, interprets that information, and returns location information, such as geographic coordinates, latitude/longitude, or other location fix data.

Network coverage module 1728 can include various sub-modules or systems, e.g., as described herein with respect to FIGS. 6 and 7. Furthermore, an altitude module (not shown) can include various sub-modules or systems, e.g., as described herein with respect to FIGS. 11-16.

The one or more application programs 1734 on the mobile device can include any applications installed on the device 1700, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 1706 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1706 can include a display and user input devices such as a keyboard, mouse, and/or track pad. In some embodiments, I/O subsystem 1706 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

1. A method performed by one or more processors of a first mobile device, comprising:
monitoring a strength of a network wireless signal;
storing a first previous location of the first mobile device at a first previous time when the strength of the network wireless signal was above a threshold;
receiving a request to provide information about previous network connectivity of the first mobile device;
responsive to the request, retrieving the first previous location; and
providing the first previous location to a user of the first mobile device.

2. The method of claim 1, wherein storing the first previous location includes:
storing, in a first table, strength information of the network wireless signal at one or more times; and
storing, in a second table, locations of the first mobile device at the one or more times.

3. The method of claim 2, further comprising:
determining the first mobile device is within a non-urban location state; and
retrieving the first previous location based on the first previous location being the non-urban location state.

4. The method of claim 3, further comprising:
retrieving a set of previous locations between a current location of the first mobile device and the first previous location; and
displaying on the first mobile device a path from the current location to the first previous location, the path including the set of previous locations.

5. The method of claim 3, wherein determining the first mobile device is within the non-urban location state uses one or more of: detectability of other network wireless signals at earlier times than the first previous time, one or more motion states of the first mobile device at the earlier times, and a classification of one or more map tiles within which the first mobile device resided at the earlier times.

6. The method of claim 5, wherein the classification of one or more map tiles is whether a map tile is within an urban area.

7. The method of claim 1, wherein the first previous location is measured using GPS.

8. The method of claim 1, wherein the network wireless signal is an in-network signal, an out-of-network signal, or a satellite signal.

9. The method of claim 1, wherein the strength of the network wireless signal is monitored at a second mobile device that is in local communication with the first mobile device.

10. The method of claim 9, wherein storing the first previous location uses a shared database between the first mobile device and the second mobile device.

11. The method of claim 1, wherein the network wireless signal is received at the first mobile device.

12. The method of claim 1, further comprising:
sending a message after the first mobile device reaches the first previous location, wherein the message is an emergency message.

13. The method of claim 12, wherein the emergency message is an emergency phone call.

14. The method of claim 1, wherein the first mobile device is a wearable device.

15. The method of claim 14, wherein the wearable device is a watch.

16. A mobile device, comprising:
one or more processors; and
a memory coupled to the one or more processors, the memory storing instructions that cause the one or more processors to perform any one or more of operations comprising:
monitoring a strength of a network wireless signal;
storing a first previous location of the mobile device at a first previous time when the strength of the network wireless signal was above a threshold;
receiving a request to provide information about previous network connectivity of the mobile device;
responsive to the request, retrieving the first previous location; and
providing the first previous location to a user of the mobile device.

17. The mobile device of claim 16, wherein storing the first previous location includes:
storing, in a first table, strength information of the network wireless signal at one or more times; and
storing, in a second table, locations of the mobile device at the one or more times.

18. The mobile device of claim 16, wherein the network wireless signal is an in-network signal, an out-of-network signal, or a satellite signal.

19. A non-transitory computer readable medium storing a plurality of instructions that, when executed by one or more processors of a mobile device, cause the one or more processors to perform operations comprising:
monitoring a strength of a network wireless signal;
storing a first previous location of the mobile device at a first previous time when the strength of the network wireless signal was above a threshold;
receiving a request to provide information about previous network connectivity of the mobile device;
responsive to the request, retrieving the first previous location; and
providing the first previous location to a user of the mobile device.

20. The non-transitory computer readable medium of claim 19, wherein storing the first previous location includes:
storing, in a first table, strength information of the network wireless signal at one or more times; and
storing, in a second table, locations of the mobile device at the one or more times.

21. (canceled)

22. (canceled)

23. (canceled)

24. (canceled)

25. (canceled)

26. (canceled)

27. (canceled)

28. (canceled)

29. (canceled)

30. (canceled)
